(19) United States
(12) Patent Application Publication
(10) Pub. No.: US 2002/0083178 A1
(43) Pub. Date: Jun. 27, 2002

(54) Resource distribution in network environment

(76) Inventor: John David West Brothers, Alpharetta, GA (US)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(21) Appl. No.: 09/922,209

(22) Filed: Aug. 3, 2001

Related U.S. Application Data
(60) Provisional application No. 60/224,907, filed on Aug. 11, 2000.

(51) Int. Cl. G06F 15/16; G06F 15/173

(52) U.S. Cl. 709/226; 709/218

(57) ABSTRACT

A resource provider subsystem (“RPS”) secures and combines resource access right data with a universal resource locator (URL) as a secure URL in a web page document. The RPS transmits the web page document with the secure URL including resource access right data, to a web access device (“WAD”) via a network. The WAD executes a browser application to display the secure URL of the web page document. A user of the WAD can activate the secure URL to generate a signal. The signal includes the secure URL and is transmitted from the WAD to the resource distribution subsystem (“RDS”). The RDS receives the signal, authenticates the request, and verifies that the resource access right data has not been changed after it was established by the RPS. If the request is authenticated and verified, the RDS uses the resource access right data to determine the rights the WAD and/or user thereof has with respect to the resource. If authorized, the RDS provides access to the resource to the WAD. The resource can include data, text, image(s), applet(s), and/or a downloadable program module. Alternatively, the resource can be a server application optionally programmed to permit the user of the web access device to interact therewith. Through use of the secure URL, the RPS can control access to the resource even though it is hosted at distributed sites of a network.

### CROSS-REFERENCE TO RELATED APPLICATIONS

This application claims priority benefits under 37 C.F.R. 1.53(c) and 35 U.S.C. 119(e) to provisional application 60/224,907 filed Aug. 11, 200, naming John David West Brothers as sole inventor.

### FIELD OF THE INVENTION

1. Background of the Invention

This invention is directed to a system for distributing a resource in a network environment for access by users on a restricted basis. The resource can be a computer program(s), applet(s), text file(s), and/or image file(s), for example. Such resources can be activated or provided to a user's web access device upon authentication and validation of a request from such user's device. The invention permits a resource to be distributed on a limited-access basis in a network environment. The invention is also directed to related subsystems, devices, methods, and articles.

2. Description of the Related Art

Internet-based resource providers typically offer data or computer program(s) accessible to users via the Internet. A data resource can include news, information, or entertainment in the form of text and/or images. A computer program resource can include any software accessible to users via the Internet. Such computer software can include transaction software for buying or selling products or services via the Internet, applications such as map locators or other software providing an application to Internet users.

Although some resource providers elect to maintain their own Internet infrastructure to host the data and/or computer program resource(s) they offer Internet users, there is an increasing trend to outsource some or all hosting of resources to other businesses that specialize in this activity. There are several reasons why outsourcing is attractive to a resource provider. Acquisition and maintenance of web servers, database servers, firewall servers, failovers, related software, and other equipment required to host resources is relatively costly, complex, time-consuming, and requires hiring of skilled persons to build and operate the resource-hosting infrastructure. In addition, if a resource provider hosts all of its resources, it must either build its system capabilities to support the maximum expected usage of its resources. The cost of building the hosting infrastructure to accommodate maximum-expected traffic from Internet users is often not justified relative to outsourcing some of the traffic to an outside hosting service. Hence, a resource provider often has compelling reasons to outsource hosting of resources offered its Internet users.

Another factor that resource providers must consider when hosting their resources to accommodate user traffic via the Internet pertains to the speed of response to users of the resource. It has been found that on average Internet users will wait no more than several seconds before moving on to a different website. Hence a resource provider must generally ensure adequate Internet infrastructure to be sufficiently responsive to maintain interest of Internet users. It has been found that response times to Internet users can be significantly reduced through the use of a distributed server environment. In other words, if a resource provider's hosts its resources on servers strategically distributed in different cities throughout the areas in which the user's are located, response times can be reduced greatly relative to a non-distributed server environment. For all of the above-listed reasons, distributed server environments are being increasingly utilized by resource providers to host resources.

Distributed server environments operate relatively well if the hosted resource is to be accessible to Internet users on an unrestricted basis. However, if resource access is to be restricted, distributed server environments can be difficult to operate and maintain. For example, if a user purchases a subscription to a resource from a provider, the fact that the user is authorized to access the resource must be broadcast to all servers in the distributed server system. Hence, a significant amount of data must be transmitted throughout the distributed server to maintain current records of users permitted to access resources and the extent of the permitted access rights. In addition, to enable an operator of a distributed server to effectively manage the resource, a significant amount of control over the resource must be given to the operator(s) of the distributed server(s). Many resource providers are reluctant to allow outside resource hosting operators to have significant control of their resources. It would be desirable to overcome these disadvantages of the previous technology.

Encryption and data security technologies are also relevant to this invention. One such technology is the so-called shared key encryption in which transmitting and receiving parties share the same key (e.g., a 128-bit or 256-bit key) use it to encode or decode messages transmitted via the Internet. Another approach is public key/private key pair in which a transmitter of a message uses a public key to encrypt the message, and the receiver uses a private key to decrypt the message. Also related to the invention are hash algorithms or message digests algorithms that are used to encode data transmitted over public networks such as the Internet. In general, message digest algorithms operate on data of virtually any length, and generate a fixed-length output termed a digest or hash. A digest has the following properties:

(1) different data do not map to the same digest upon application of a digest algorithm; and

(2) the digest does not reveal anything about the particular digest algorithm or data that was used to generate it.

An example of a digest algorithm is SHA-1 published by the United States Government. SHA-1 generates a one-hundred-sixty (160) bit hash from any length data string. More information on the SHA-1 algorithm is available at http://www.it1.nist.gov/fipspubs/fip180-1.htm. Another example of a digest algorithm is MD5 (Message Digest Algorithm 5) produced by RSA Laboratories, Inc. The MD5 algorithm can be used to hash a data string of any length into a one-hundred twenty-eight (128) bit value. Another digest algorithm is Tiger developed by Anderson and Biham available at ftp.funet.fi:/pub/crypt/hash/tiger. Yet another hash algorithm is RIPEMD-160 available at http://www.esat.kuleuven.ac.be/˜bosselae/ripemd160.html. RIPEMD-160 encrypts data of any length into a one-hundred sixty (160) bit string.

### SUMMARY OF THE INVENTION

Generally stated, the system, subsystems, apparatuses, and methods described in this document can be used to distribute a resource in a network environment in a manner that can be controlled by a resource provider.

A first disclosed method comprises generating hash data based on at least one of a universal resource locator (URL) of a resource, resource access right data defining restriction(s) on a web access device (WAD) and/or user thereof to access the resource, and an IP address of the WAD. The first method also comprises combining the hash data, URL, and resource access right data, in a web page. The first method can comprise transmitting the web page document including the secure URL to the WAD in response to a request for the web page document from the WAD. The hash data can be generated using key data that is combined with the URL and hashed to generate the hash data. The first method can comprise transmitting the key data from a resource provider subsystem (RPS) to a resource distribution subsystem (RDS) that is to host the resource so that, if the secure URL is activated by the WAD to generate a request for the resource to the RDS, the RDS can verify that the resource access right data has not been modified other than by the RPS. The resource access right data can include at least one of: (1) an authorized Internet protocol (IP) address or IP address range; (2) lifespan data indicating the lifespan indicating a time period over which requests for accessing a resource are valid; and/or (3) maximum reference data indicating a maximum number of times a web access device and/or user thereof can access a resource.

A second disclosed method comprises, at a resource provider subsystem (RPS), receiving a request for a web page from a web access device (WAD) via a network, and determining resource access right data for the WAD and/or a user thereof. The resource access right data defines restriction(s) for the WAD and/or user thereof to access a resource. The second method also comprises securing a universal resource locator (URL) for a resource by generating hash data based on the URL and/or resource access right data, and combining the URL, resource access right data, and hash data together in the web page. The second method further comprises transmitting the web page having the secure URL to the web access device via the network in response to the request received from the WAD. The hash data can be generated further using key data corresponding to the WAD and/or user thereof. The method can further comprise the step of transmitting key data corresponding to the web access device and/or user thereof to a resource distribution subsystem (RDS) hosting the resource so that, if the secure URL is activated by the web access device to generate a request for the resource to the RDS, the RDS can verify that the resource access right data has not been modified other than by the RPS.

A third disclosed method comprises receiving a signal requesting a web page document from a web access device (WAD). The signal includes an Internet protocol (IP) address of the WAD. The third method also comprises retrieving data for the web page document including a universal resource locator (URL) of a document referenced in the web page document, retrieving resource access right data for the URL using the IP address of the web access device and/or user name and password established through a log-in procedure, and generating hash and/or encrypted data to generate secure resource access right data. The third method further comprises combining the resource access right data with the respective URL to generate a secure URL, generating the web page document including the secure URL, and transmitting the secure URL to the WAD.

A fourth disclosed method comprises, at a web access device (WAD), transmitting a signal requesting a web page document to a resource provider subsystem (RPS), and receiving the web page document having a secure universal resource locator (URL) with hash data, URL, and resource access right data, in response to the request. The fourth method can also comprise activating the secure URL with the WAD to transmit a signal requesting access to a resource designated by the URL to a resource distribution subsystem (RDS), and accessing the resource with the WAD if the RDS determines that access to the resource is authorized based on the hash data and resource access right data contained in the request signal.

A fifth disclosed method comprises, at a web access device (WAD), generating and transmitting a request for a web page document to a resource provider subsystem (RPS), and receiving the requested web page document having a secure universal resource locator (URL) with secured resource access right data from the resource provider subsystem (RPS). The fifth method also comprises executing a browser application and web page document with the WAD to generate and transmit a signal to request a resource distribution subsystem (RDS) to provide access to a resource identified by the secure URL. The request signal can include the URL and secure resource access right data. The fifth method further comprises, if access to the resource is permitted by the RDS, accessing the resource with the WAD. The accessing of the resource can be performed in different ways, depending upon the nature of the resource. For example, the accessing of the resource in the fifth method can comprise substeps of receiving at the WAD resource data from the RDS, storing the resource data in memory of the WAD, executing an application with the WAD based on the resource data to generate a signal, and generating a display with the WAD based on the generated signal. Alternatively, the accessing of the resource in the fifth method can comprise receiving a program module resource from the RDS, loading the program module resource into memory of the WAD, executing the program module resource with the EAD to generate a signal, storing the signal(s) in memory, and generating a display with the WAD based on the generated signal. As yet another alternative, the accessing of the resource in the fifth method can comprise receiving at the WAD via the network a signal from the RDS generated based on execution of a server application by the RDS, storing the received signal in the memory of the WAD, generating with the WAD a display signal based on the received signal, generating a display with the WAD based on the display signal, executing a client application with the WAD to generate a signal based on the signal from the RDS, and transmitting the signal(s) to the RDS via the network. The fifth method can further comprise receiving input data at the WAD from a user. The client application can be executed based on the input data.

A sixth method comprises, at a resource distribution subsystem (RDS), receiving a signal requesting access to a resource from a web access device (WAD). The signal includes at least a universal resource locator (URL), resource access right data, and hash data. The sixth method also comprises verifying that the resource access right data as set by a resource provider subsystem (RPS) has not been changed, using the hash data. The sixth method further comprises, if the verifying establishes that the resource access right data has not been changed, determining whether access to the resource is permitted to the WAD and/or user thereof based on the resource access right data. The sixth method further comprises, if the resource access right data indicates that the WAD and/or user thereof is authorized to access the resource, permitting access to the resource to the WAD and/or user thereof. The resource access right data can include at least one of an authorized Internet protocol (IP) address or IP address range, lifespan data indicating the lifespan indicating a time period over which requests for accessing a resource are valid, and maximum reference data indicating a maximum number of times a web access device and/or user thereof can access a resource. The hash data can be generated based on the URL, resource access right data, and key data. The sixth method can further comprise receiving key data from the RPS for use in verifying that the resource access right data has not changed from establishment by the RPS. The key data can include a key and optionally at least one of: (1) a second URL identifying the RPS; (2) start date/time data identifying a date and time at which a key is valid; (3) end date/time data identifying a date and time at which a key becomes invalid; (4) lifespan data indicating a period of time over which the key is valid; (5) key index data identifying the key from among a plurality of different keys; (6) hash identifier data indicating to the RDS a hash algorithm to be performed to generate the hash data; (7) encryption data indicating an encryption model and/or algorithm used to encrypt and decrypt resource access right data; and (8) format fields data indicating the number of fields in the signal requesting access to the resource.

A seventh disclosed method comprises receiving a signal requesting access to a resource. The signal has a secure universal resource locator (URL) with secured resource access right data. The seventh method also comprises extracting an Internet protocol (IP) address from the secured resource access right data, comparing the extracted IP address with the IP address included in a hypertext transport protocol (HTTP) message of the request signal, and authenticating that the IP address of the secured resource access right data corresponds to the IP address of a device requesting access to the resource, based on the comparing. The seventh method can comprise terminating the request signal if the authenticating indicates that the IP address of the secured resource access right data does not match the IP address extracted from the HTTP message. The seventh method can also comprise, if the authenticating indicates that the IP address of the secure resource access right data matches the IP address of the device requesting access to the resource, obtaining a key corresponding to the IP address. The seventh method can also comprise verifying whether the key is valid based on data corresponding to the key in a secure content key database, generating hash data based on at least the IP address, URL, and key, and verifying that the generated hash data matches the hash data included in the received request signal. The seventh method further comprises terminating the request signal if the verifying indicates that the generated hash data does not match the hash data included in the received request signal. The seventh method can comprise determining whether access to a resource is to be provided to a device identified by the IP address, based on the resource access right data included in the request signal. The seventh method can also comprise retrieving the resource based on the URL included within the request signal, and providing access to the resource to a device identified by the IP address if the determining indicates that access to the resource is to be provided, based on the URL. The seventh method can further comprise retrieving resource access right data from a database. The access determination can be performed based further on whether the IP address of the request signal is authorized to access the resource indicated by the URL of the request signal, based on the retrieved resource access right data. Furthermore, the seventh method can comprise terminating the request signal if the determining indicates that access to the resource is not to be provided based on the resource access right data included in the request signal. The retrieved resource access right data can include maximum reference data and reference count data. The seventh method can further comprise incrementing the reference count data to indicate that access to the resource has been requested by the request signal, comparing the incremented reference count data with the maximum reference count data, and providing access to the resource if the comparing indicates that the incremented reference count data does not exceed the maximum reference count data. Furthermore, the retrieved resource access right data can include lifespan data for access to the resource indicated by the URL. The seventh method can further comprise determining a time and date of receiving the request signal, comparing the lifespan data with the time and date of receiving the requesting signal, and determining that the IP address of the request signal is authorized to access the resource, if the comparing indicates that the time and date of receiving the request signal is within the lifespan data. The retrieved resource access right data can include URL/resource provider identification data. The seventh method can further comprise retrieving the resource from a resource provider subsystem via the Internet, based on the URL/resource provider identification data so that access can be provided thereto. The retrieved resource access right data can include retrieval key data used to decrypt the retrieved resource.

An eighth method comprises receiving a signal requesting access to a resource. The request signal can include a universal resource locator (URL), secured resource access right data, and an Internet protocol (IP) address of a device requesting access to the resource, and hash data. The eighth method further comprises verifying whether the key data is valid based on data corresponding to the key data in a secure content key database. The eighth method also comprises, if the key data is verified as valid, generating hash data based on at least the IP address, URL, and key. The eighth method further comprises verifying that the generated hash data matches the hash data included in the received request signal. The eighth method can comprise terminating the request signal if the verifying indicates that the generated hash data does not match the hash data included in the received request signal. The eighth method can comprise determining whether access to a resource is to be provided to a device identified by the IP address, based on the resource access right data included in the request signal, and providing access to the resource to a device identified by the IP address if the determining indicates that access to the resource is to be provided. The eighth method can also comprise retrieving resource access right data from a database. The determining can be based further on whether the IP address of the request signal is authorized to access the resource indicated by the URL of the request signal, based on the retrieved resource access right data. The received request signal can comprise key index data used to retrieve the key data from the secure content key database. The validity of the key data can be established by determining a date and time of receiving the request signal, retrieving start date/time data and end date/time date from a database, comparing the date and time of the request signal with the start date/time data and end date/time data, and determining whether the key data is valid, based on the comparing. Alternatively, the validity of the key data can be established by determining a date and time of receiving the request signal, retrieving lifespan data from a database, comparing the date and time of receiving the request signal with the lifespan data, and determining whether the key data is valid, based on the comparing.

A ninth disclosed method comprises receiving via the Internet a request signal including a universal resource locator (URL) indicating a location of a resource, secured resource access right data indicating rights of a device to access the resource, and an Internet protocol (IP) address of the device. The ninth method also comprises determining whether access to the resource is to be provided to the device identified by the IP address, based on secured resource access right data included in the request signal. The ninth method further comprises providing access to the resource to a device identified by the IP address if the determining indicates that access to the resource is to be provided. The ninth method can comprise terminating the request signal if the determining indicates that access to the device is not authorized. The ninth method can comprise transmitting the resource to the device via the Internet. Furthermore, the ninth method can comprise authenticating the request signal if an Internet protocol (IP) address of the URL in the request signal matches a URL of the device contained in the resource access right data of the request signal. Furthermore, the ninth method can comprise retrieving resource access right data from a database, and the access determination can be further based on whether the IP address of the request signal is authorized to access the resource indicated by the URL of the request signal, using the retrieved resource access right data. Moreover, the ninth method can comprise verifying validity of key data, generating hash data based on at least the URL and the key data, comparing the generated hash data with hash data included in the received request signal, and determining whether the generated hash data matches the hash data generated in the request signal, based on the comparing of hash data. Access to the resource can be provided if the determination establishes that the hash data match. The verifying of the key data can be performed by determining a date and time of receiving the request signal, retrieving start date/time data and end date/time date from a database, comparing the date and time of the request signal with the start date/time data and end date/time data, and determining whether key data is valid, based on the comparing. If the key data is determined valid, the determination of whether access to the resource is permitted can be performed. Conversely, if the key data is not valid, the request signal can be terminated. The verifying of key data can also be performed by determining a date and time of receiving the request signal, retrieving lifespan data from a database, comparing the date and time of receiving the request signal with the lifespan data, and determining whether key data is valid, based on the comparing. If the key data is determined valid, the determination of whether access to the resource is permitted can be performed. Conversely, if the key data is not valid, the request signal can be terminated.

A disclosed system can be used in connection with the Internet. The system comprises at least one web access device (WAD) executing a browser application. The WAD generates a signal requesting a web page document having a secure universal resource locator (URL), displays the web page document having the secure URL, and generates a signal requesting a resource indicated by the secure URL of the web page document. The system also comprises resource provider subsystem (RPS) coupled to receive via the Internet the signal requesting the web page document from the WAD. The RPS generates the secure URL to include resource access right data defining restriction(s) of the WAD and/or user thereof to access the resource indicated by the URL. The RPS transmits the web page document with the secure URL to the WAD. The system further comprises at least one resource distribution subsystem (RDS) coupled to receive via the Internet the signal from the WAD requesting access to the resource. The RDS determines whether the resource access right data has been changed from establishment by the RPS, and, if the RDS determines that the resource access right data has not been changed, the RDS determines whether the WAD and/or user thereof is authorized to access the resource using the resource access right data. The RDS permits access to the resource if the WAD and/or user thereof is authorized to access the resource. The resource access right data can include at least one of: (1) an authorized Internet protocol (IP) address or IP address range; (2) lifespan data indicating the lifespan indicating a time period over which requests for accessing a resource are valid; and/or (3) maximum reference data indicating a maximum number of times a web access device and/or user thereof can access a resource. The hash data can be generated by the RPS based on the URL, resource access right data, and key data. The RDS can store the key data used by the RPS for use in verifying that the resource access right data has not changed from establishment by the RPS. The key data can comprise a key and optionally at least one of: (1) a second URL identifying the RPS, (2) start date/time data identifying a date and time at which a key is valid, (3) end date/time data identifying a date and time at which a key becomes invalid, (4) lifespan data indicating a period of time over which the key is valid, (5) key index data identifying the key from among a plurality of different keys, (6) hash identifier data indicating to the RDS a hash algorithm to be performed to generate the hash data, (7) encryption data indicating an encryption model and/or algorithm used to encrypt and decrypt resource access right data; and/or (8) format fields data indicating the number of fields in the signal requesting access to the resource.

A first disclosed server stores a secure universal resource locator (URL) generator module executable by the server to generate a URL having secure resource access right data defining restriction(s) on a web access device (WAD) and/or user thereof to access a resource indicated by the secure URL. The resource access right data is secured by the server so that modification of the resource access right data can be detected. The server can store a secure content key database having key data, and the server can execute the secure URL generator module to secure the resource access right data with the key data. The server can append the key data to an Internet protocol (IP) address of the WAD requesting the web page document from the server, and can hash the key data and the IP address to generate hash data. The hash data can be combined with the URL and resource access right data to generate the secure URL. The server can use the key data to encrypt the resource access right data and can combine the encrypted resource access right data with the URL to produce the secure URL. The server can comprise a resource access right database storing the resource access right data. The server can comprise an access right enforcer module, that the server can execute to determine whether a resource is to be provided to another server in response to a request signal received from the other server via the Internet. The server can execute a secure caching module to transmit the resource to the other server for distribution if the resource access right data indicates that the other server is authorized to access the resource. Conversely, the server can prevent access to the other server if the resource access right data indicates that the other server is not authorized to access the resource.

A second disclosed server of a resource distribution subsystem (RDS) stores an access right enforcer module executable by the server. The server executes the access right enforcer module in response to a signal from a web access device (WAD) requesting access to a resource. The request signal has a universal resource locator (URL) with secure resource access right data. The server executes the access right enforcer module using resource access right data to determine whether the resource access right data has been modified after its establishment by a resource provider subsystem (RPS). If the resource access right data has not been changed, the server executes a secure caching module to provide access to the resource, provided that the WAD is determined to have the right to access the resource as determined by the resource access right data. The server blocks access to the resource if the resource access right data has been changed or if the WAD is determined not to have the right to access the resource from the resource access right data. The request signal received by the server from the WAD can include an Internet protocol (IP) address, a universal resource locator (URL) indicating the location of the resource, and hash data. The server can retrieve key data based on the IP address and/or URL. The server can combine the key data with at least the IP address and/or URL. The server can generate hash data based on the key data and IP address and/or URL. The server can compare the server-generated hash data with the hash data in the request signal. If the hash data matches, the server can execute its secure caching module to provide access to the resource. Conversely, if the hash data do not match, the server can block access to the resource. The server can retrieve date/time data from a secure content key database stored therein. The date/time data can indicate a period of time over which the key data is valid. The server can record the date and time of receiving the request signal at the server and can compare the date and time of receipt of the request signal with the date/time data to determine whether the key data is valid. The server can permit further processing of the request signal if the comparison indicates the key data is valid, and can terminate further processing of the request signal if the date/time data indicates the key data is not valid. The server can further retrieve from the secure content key database life span data that the server uses in conjunction with the date/time data to determine the period of time over which the key is valid so that date and time of receiving the request signal at the server can be compared by the server with the date/time data and lifespan data to determine whether the key is valid.

Details of the construction and operation of the invention are more fully hereinafter described and claimed. In the detailed description, reference is made to the accompanying drawings, forming a part of this disclosure, in which like numerals refer to like parts throughout the several views.

### BRIEF DESCRIPTION OF THE DRAWINGS

FIGS. 1A-1G are views of a method of the invention illustrating how a resource can be distributed within a system of the invention;

FIGS. 2A-2E are views of a method of the invention indicating a resource can be accessed at a distribution server in the system;

FIG. 3 is a block diagram of a web access device (WAD) of the invention;

FIG. 4A is a flow chart of a method performed by a WAD to obtain access to a resource, and FIGS. 4B-4D are flowcharts of methods indicating how access to the resource is provided to a WAD depending upon the nature of the resource;

FIG. 5 is a block diagram of a resource provider subsystem (“RPS”) of the invention;

FIG. 6 is a flowchart of processing performed by a web server of the RPS;

FIG. 7 is a block diagram of a resource distribution subsystem (“RDS”) of the invention;

FIG. 8 is a flowchart of processing performed by the resource distribution server of the invention;

FIGS. 9A-9B show a secure content key database for storing hash keys and data for use in validating hash keys;

FIG. 9C is a database for storing resource access right data;

FIGS. 10A-10C indicate different formats for the unsecure and secure URL having resource access right data;

FIG. 11A is a block diagram of a method for generating a secure URL having resource access right data;

FIG. 11B is a block diagram of a method of generating a web page document having a secure URL with resource access right data;

FIG. 12 is a block diagram of a method for decoding resource access right data;

FIG. 13A is a flowchart of a method of authenticating an IP address of a WAD at a server of a RDS;

FIG. 13B is a flowchart of processing performed to check the field format of a secure URL with resource access right data received at a server of a RDS;

FIG. 13C is a flowchart of hash key validation performed by a server of a RDS;

FIG. 13D is a flowchart of hash verification performed by a server of a RDS;

FIG. 13E is a flowchart of resource access right verification performed by a server of a RDS;

FIG. 13F is a flowchart of resource access verification performed by server of a RDS;

FIG. 13G is a flowchart of resource access verification performed by a server of a RDS;

FIG. 13H is a flowchart of resource access verification performed by a server of a RDS;

FIG. 13I is a flowchart of resource access verification performed by a server of a RDS;

FIG. 14 is a block diagram of a resource handler for providing resource data to a WAD;

FIG. 15 is a resource handler for loading and launching an application resource in response to a request from a WAD; and

FIG. 16 is a schematic diagram of a resource distribution network system in accordance with the invention.

### DESCRIPTION OF THE PREFERRED EMBODIMENTS

### 1. Definitions

“And/or” means either or both.

“Authentication” refers to verification that a resource provider has authorized access to a resource to a particular web access device, an Internet Protocol (IP) address thereof, or a user. Authentication can be performed by comparing an Internet protocol (IP) address in a hypertext transport protocol (HTTP) request signal with the IP address in a secure URL portion of the request signal. Alternatively, or in addition, authentication may be performed by successful decoding of resource access right data, or by performing a hash algorithm on resource access right data and comparing the hash with that received with a request for access to the resource from a web access device.

“Communication interface unit” can include a modulator/demodulator (“modem”), a waveguide, optical or wireless transceiver, Ethernet® card, or other device that permits a server or device to access a network.

“Coupled” refers to joining a web access device(s), server(s), or database storage unit(s) so as to permit signals to propagate therebetween. Such signals can be in electronic form and transmitted between coupled elements by a conductive line such as a wire or cable or other waveguide, or via wireless transmission of signals through air or other media, for example. Alternatively, such signals can be in optical form and transmitted via optical fiber or other waveguide, or by transmission of signals through air, space or other media, for example.

“Client” is a program or device that is capable of accessing shared network resources provided by a server.

“Data storage unit” refers to a memory storage with random-access memory, hard-disk drive, tape or other storage medium type for the storage of data. The data storage unit can be controlled with commercially-available software packages such as Oracle 9i from Oracle® Corporation, Redwood City, Calif. The web server can communicate with the data storage unit through an application program interface (API) such as Java DataBase Connectivity (JDBC) or Open DataBase Connectivity (ODBC).

“Display unit” can be a flat-panel liquid crystal display (LCD) or a cathode ray tube (CRT), for example.

“Document”, “web page” or “web page document” refers to a document in hypertext mark-up language (HTML), extensible mark-up language (XML), or other language that includes a computer-readable code that can be used to generate a display with a web browser.

“Encode” refers to preparing a URL string in a manner that can be interpreted by an operating system and/or application hosted on a server.

“File” refers to a set or collection of data.

“Graphical user interface” or “GUI” refers to the display and input unit of a web access device that a user operates to interact with the web access device.

“Input device” refers to a keyboard, mouse, wand or any other device that can be operated by a user to input commands or data into a web access device.

“Key” or “key data” refers to a series of bits used for hashing or encrypting/decrypting data.

“Log in” and “log out” refer to beginning and ending steps of a session of interaction between a web access device and a server. Generally, “log in” entails entering user name and password at a web access device and submitting these to a server. The server and/or database storage unit can be used to store user data associated with the user name and password.

“Memory” or “Processor-readable memory” includes a random-access memory (RAM), read-only memory (ROM), programmable read-only memory (PROM), electrically-erasable read-only memory (EEPROM), compact disc (CD), digital versatile disc (DVD), a magnetic storage medium such as a floppy disk or cassette, hard disk drive, and/or other storage device. Such memory can have a byte storage capacity from one Megabyte to several Gigabytes or more, for example.

“Module” refers to computer code executable by a processor of a computer or server.

“Network” can be local area network (LAN), wide area network (WAN), metropolitan area network (MAN), “the Internet”, a virtual private network (VPN) or other network, for example. The “network” establishes communication between applications running on web access device and server(s). Such communication can be in accordance with the ISO/OSI model, for example.

“Operator” refers to a programmer or systems administrator of either the resource provider subsystem (“RPS”) or the resource distribution subsystem (“RDS”).

“Operating system” is a computer program that enables a processor within a web server or web access device to communicate with other elements of such systems. Such operating systems can include Microsoft® Windows 2000™, Windows NT™, Windows 95™, Windows 98™, or disc-operating system (DOS), for example. Such operating systems can also include the Java-based Solaris® operating system by Sun Microsystems, the UNIX® operating system, LINUX® operating system, and others.

“Processor” can be a microprocessor such as a Pentium® series microprocessor commercially-available from Intel® Corporation, a microcontroller, programmable logic array (PLA), field programmable gate array (FPGA), programmable logic device (PLD), programmed array logic (PAL), or other device.

“Processor-readable medium” includes an electronic, magnetic, magnetoelectronic, micromechanical, or optical data storage media. The computer-readable medium can include compact-disk read-only memory (CD-ROM), digital versatile disk (DVD), magnetic media such as a floppy-disk or hard-disk, hard-disk storage units, tape or other data storage medium.

“Resource access right data” is data that can be used to limit or control access to a resource.

“Resource” can be data, text, an image file(s), sound file(s), video file(s), one or more web page documents and/or an application or computer program, or data, text, and image file(s), sound file(s), video file(s) resulting from execution of a computer program.

“Server” is a computer or program operating on the Internet or other network environment, that responds to commands from a client.

“(s)” at the end of a word means “one or more.” For example, “part(s)” means “one or more parts.”

“Transmission media” includes an optical fiber, wire, cable, or other media for transmitting data in optical or electric form.

“Universal Resource Locator” or “URL” is the address of a device such as a client or server accessible via Internetwork.

“User” generally refers to a human operator of a web access device.

“Web access device” is a device that accesses resources of another device (e.g., server) via a network. The web access device can be a personal computer, a network terminal, a personal digital assistant, or other computing or processor-based device.

“Web browser” or “browser” is an application program that has the capability to execute and display an HTML and/or extensible mark-up language (XML) document, for example, and that interacts with one or more servers via a network. For example, the web browser can be Internet Explorer® version 5 program available from Microsoft® Corporation, Redmond, Wash., or Communicator® version 4.5 program available from Netscape, Inc. “Web browser” also encompasses within its meaning HTML and/or XML viewers such as those used for personal digital assistants (PDAs).

“Web server” generally refers to a computing device available commercially from numerous sources such as Alpha Microsystems®, Santa Ana, Calif., Intel® Corporation, Hewlett-Packard® Corporation, Sun Microsystems®, Inc. capable of serving data or files to client applications via hypertext-transport protocol (HTTP) and executing server-based applications such as CGI scripts, or Java® servlets, or Active server pages, for example.

### 2. General System and Method

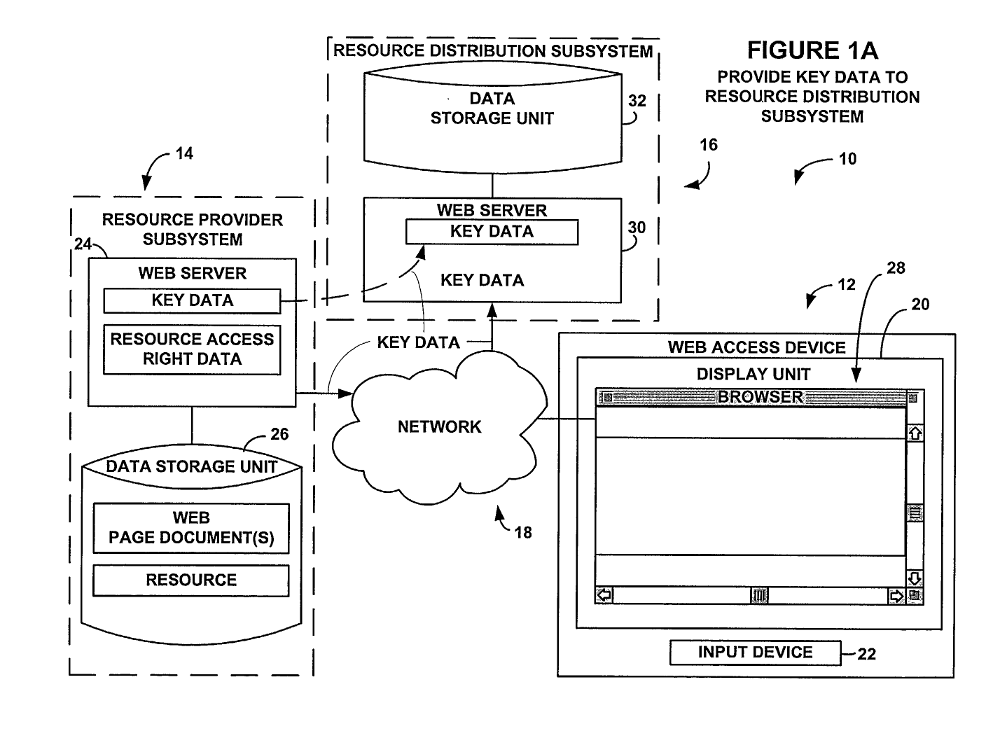

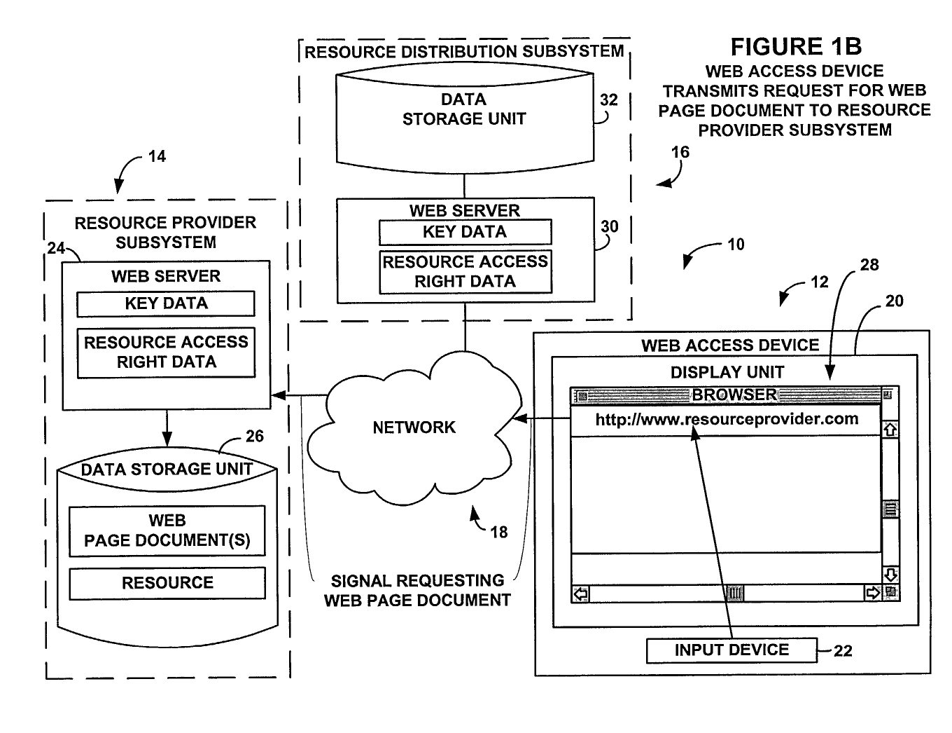

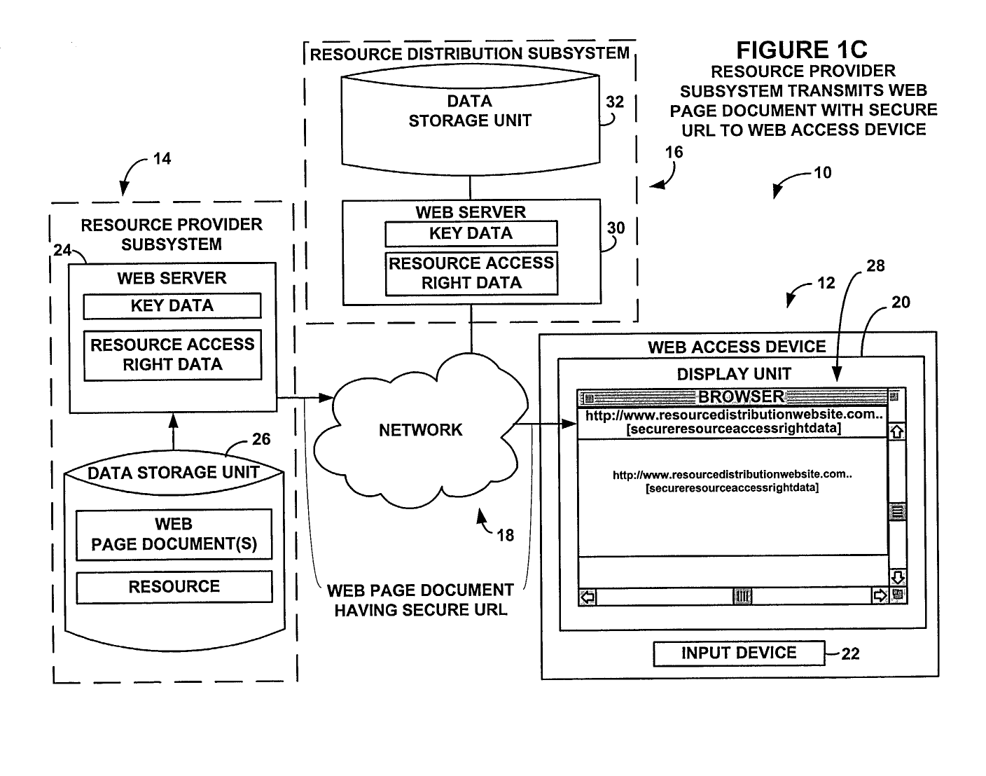

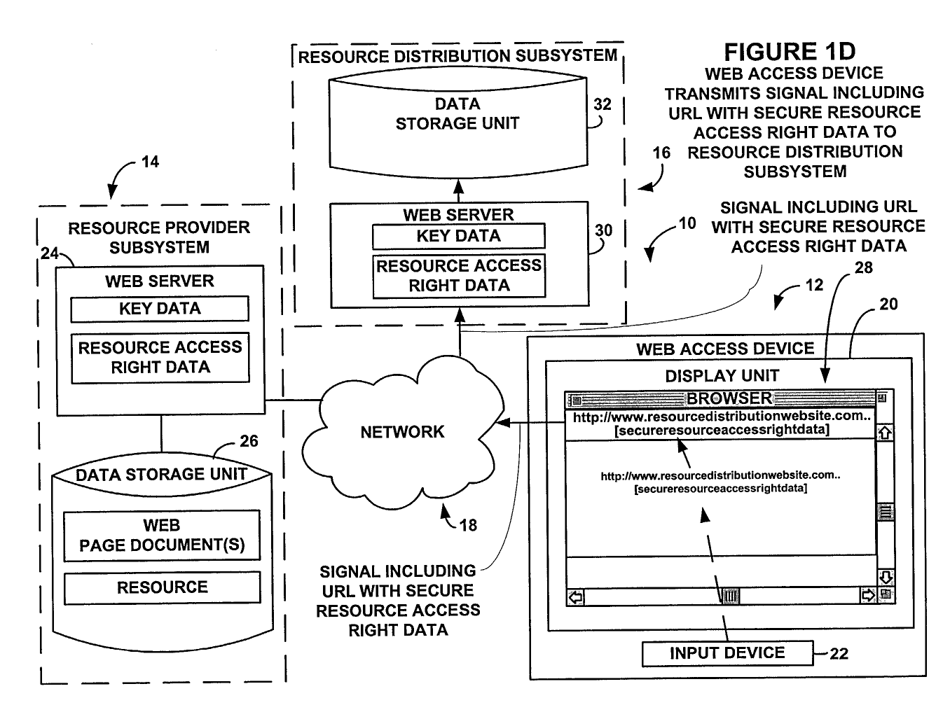

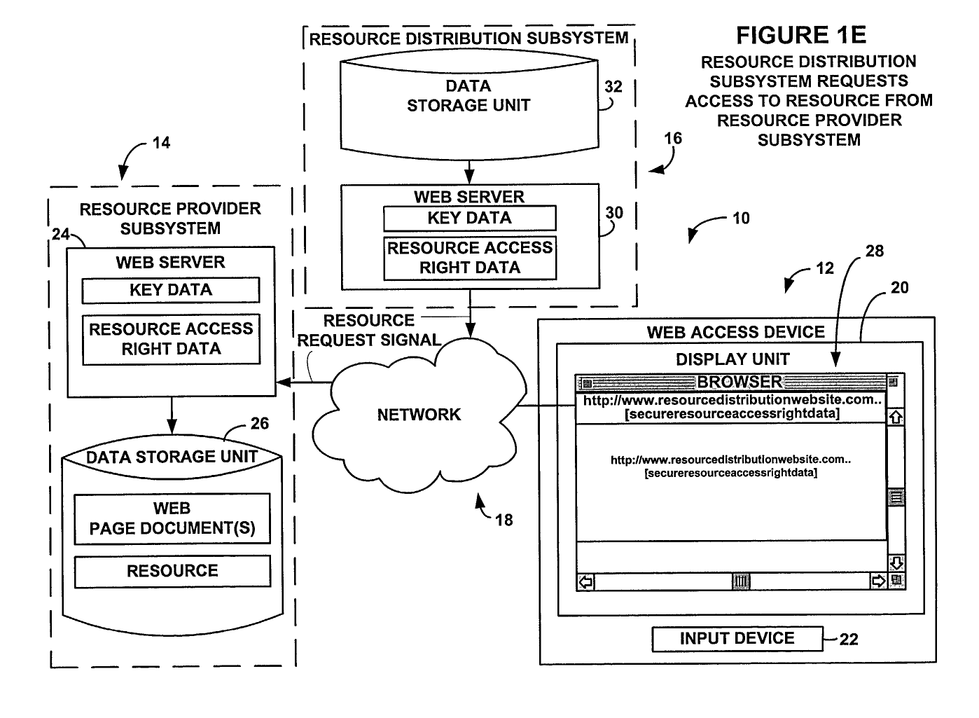

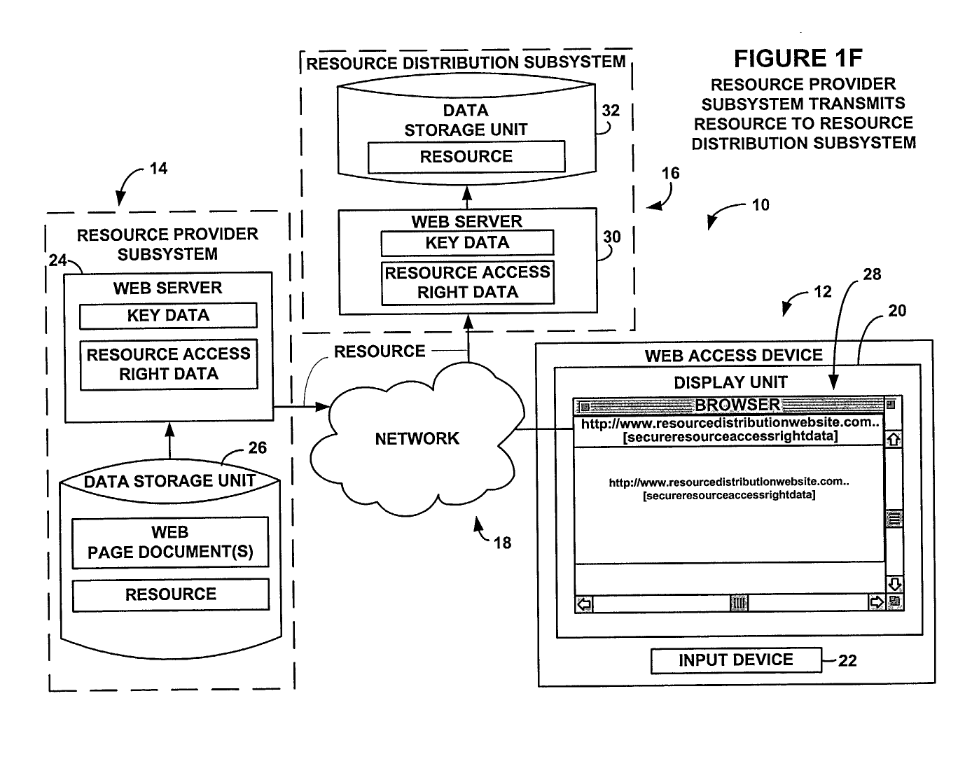

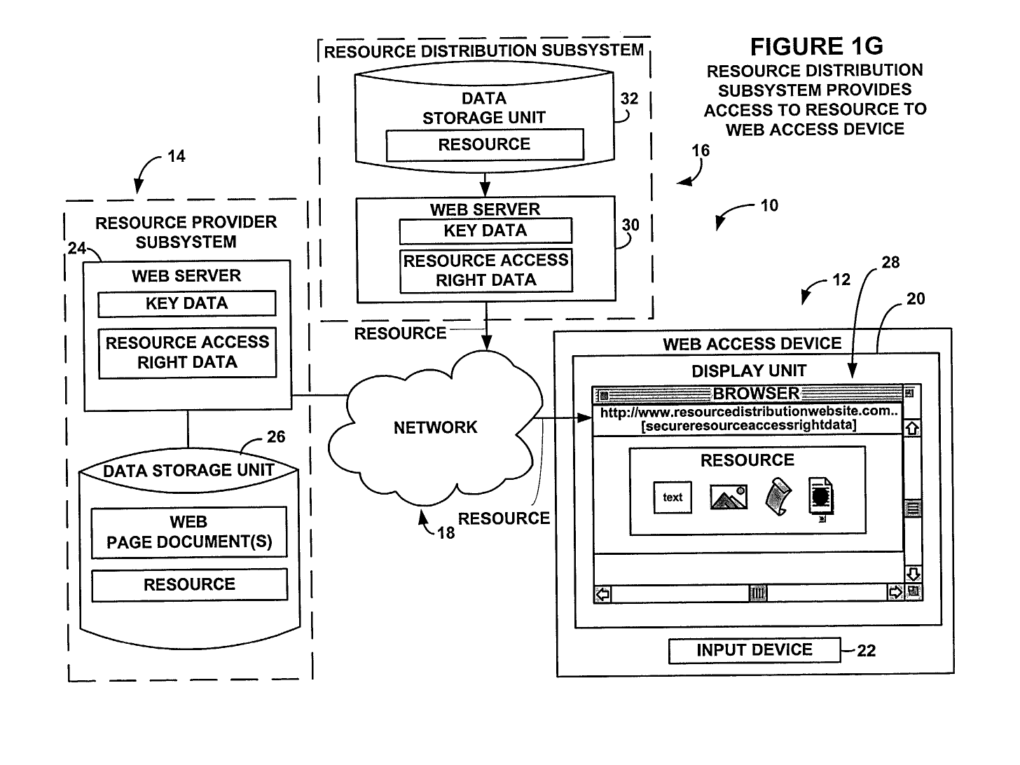

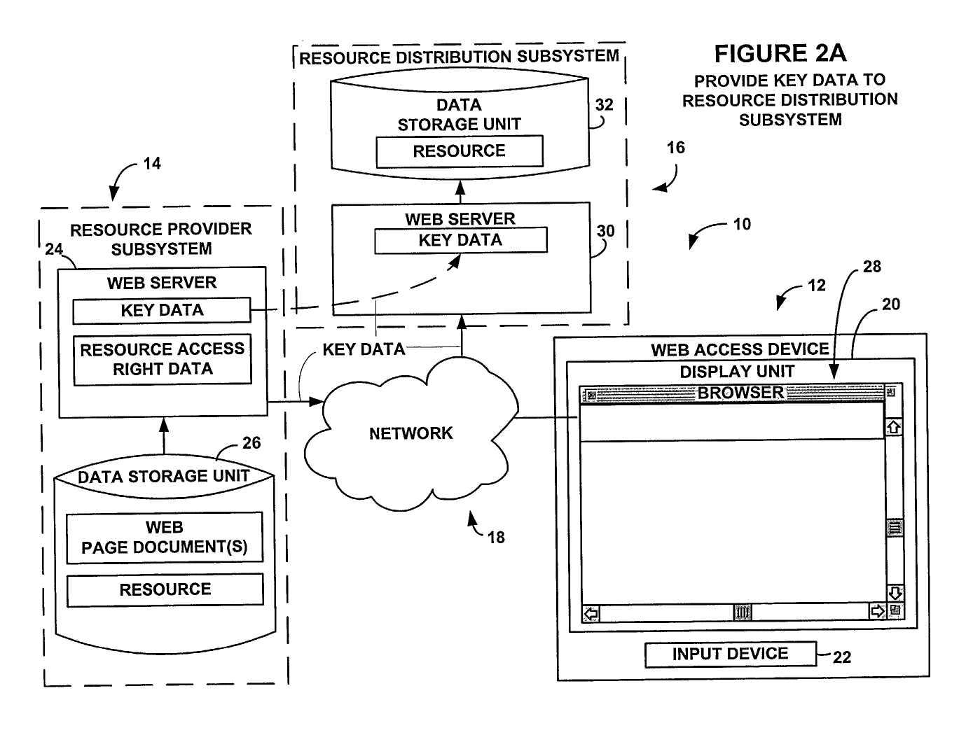

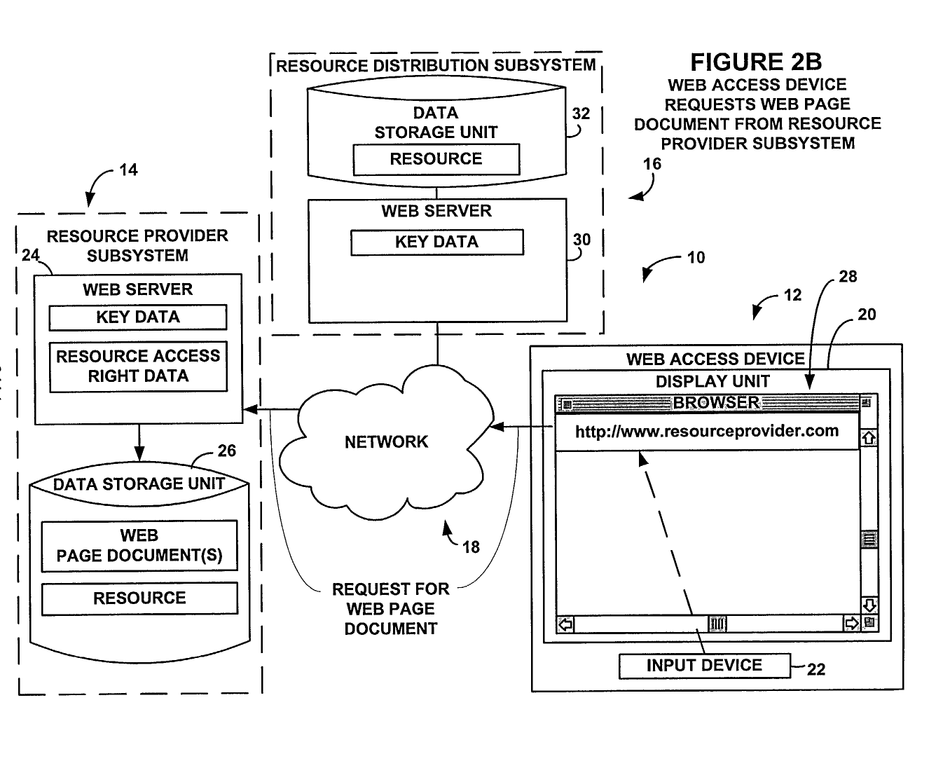

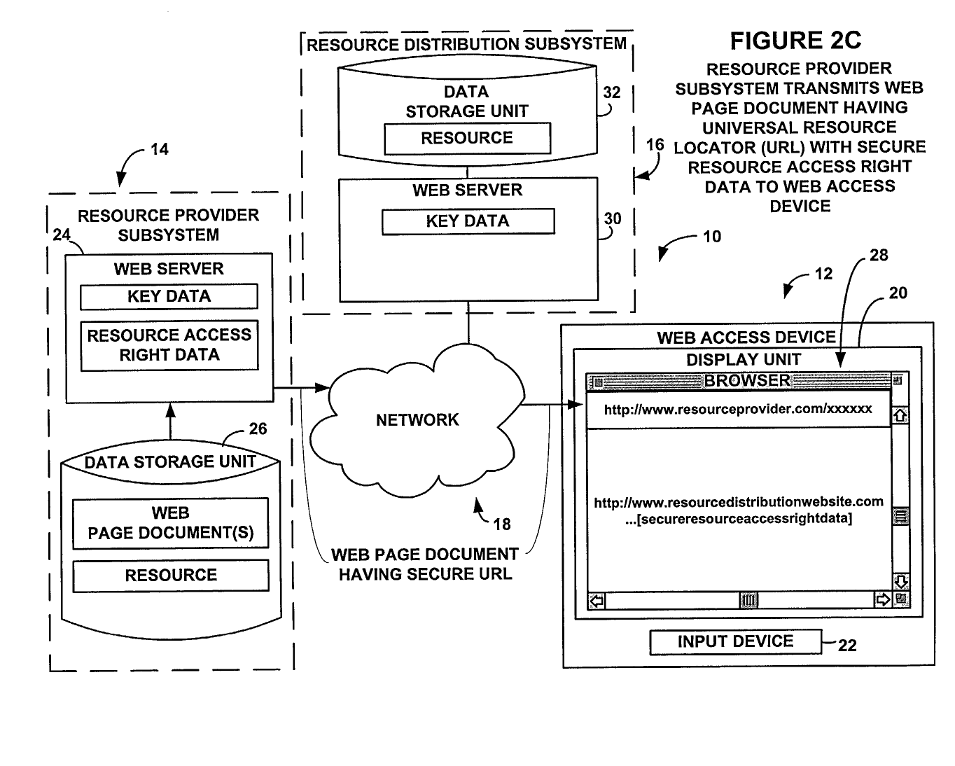

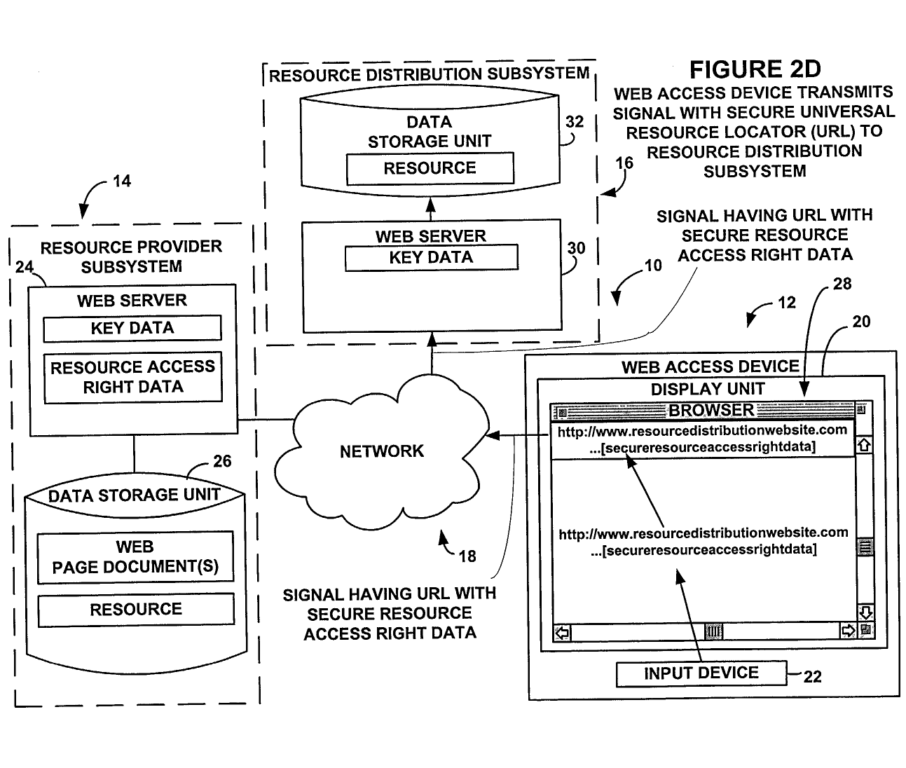

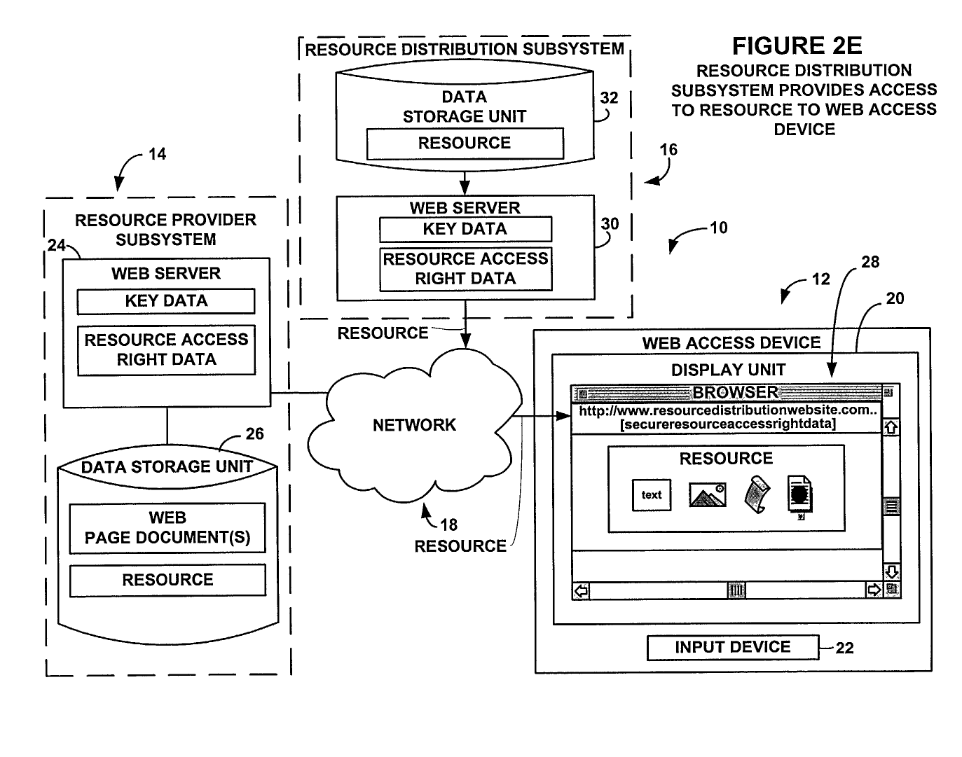

FIGS. 1A-1G and 2A-2E are views of a general system 10 that comprises web access device 12, resource provider subsystem (“RPS”) 14, resource distribution subsystem (“RDS”) 16, coupled via network 18. The web access device 12 can be a processor-based device capable of executing a browser application. The web access device 12 can include a display unit 20 and an input device 22. In FIG. 1A, the web server 30 of the RDS 16 is provisioned with key data stored in the RPS 24. The key data permits the subsystem 16 to authenticate and verify requests to access a resource from a user and/or web access device. In FIG. 1B, the web access device (WAD) 12 generates a signal requesting a web page document from the RPS 14. The WAD 22 can be programmed to generate this request signal automatically, or a user of the WAD 22 can operate the input device 22 to generate such signal. The WAD 12 transmits the request signal to the RPS 14 via the network 18.

The RPS 14 can include a web server 24 and a data storage unit 26. The web server 24 is coupled to receive the request signal from the WAD 12 via the network 18, and retrieves the requested web page document from the data storage unit 26, as shown in FIG. 1C. Alternatively, in response to the request signal, the web server 24 can retrieve data from the data storage unit 26 for use in assembling a web page document “on-the-fly” for transmission to the WAD 12. The web server 24 finds any universal resource locator(s) (URL) referenced in an existing web page document or to be included within a web page document assembled on-the-fly by the web server 24. The web server 24 is programmed to associate resource access right data with the URL. The resource access right data defines the WAD's and/or user's rights to access the resource. The web server 24 can also associate a file path indicating the data storage location of the resource at the RPS 14 and/or the RDS 16 in the secure URL.

The web server 24 can retrieve the resource access right data based on one or more factors. The web server 24 can include a data table storing resource access right data in correspondence with the identity of the user of the WAD. The user's identity can be determined by web server 24 from a log-in procedure to commence a session between the WAD 20 and the web server 24. Alternatively, the user's identity can be determined by the web server 24 if a cookie has been previously loaded into the WAD 12 to identify the WAD and/or user thereof to the web server 24. Alternatively, or in addition, the web server 24 can store the resource access right data in correspondence with an IP address of the WAD 12. The IP address of the WAD 12 is inherently supplied to the web server 24 in the request signal in the IP protocol in version 3.0 and later versions of this protocol established by the Institute of Electrical and Electronics Engineering (IEEE). The web server 24 can thus retrieve the resource access right data based on the identity of the WAD 12 and/or the user thereof. The web server 24 also retrieves from a data table stored therein hash and/or encryption key data for hashed and/or encrypted data included as part of the resource access right data. The hash and/or encryption key data can be stored in the web server 24 in correspondence with the URL or identity of the server hosting the resource. The web server 24 retrieves the hash and/or encryption key and uses it to hash and/or encrypt the retrieved resource access right data. As shown in FIG. 1B, the web server 24 combines the resource access right data with the URL and encodes the resulting secure URL data string into a form that can be executed by web server 30. Depending upon how the web server 30 is programmed, such web server can either replace an existing URL with the secure URL or may combine the secure URL with other elements of the web page document “on the fly” as such web server generates the web page document. The web server 24 transmits the web page document having the secure URL with the secure resource access right data to the WAD 12 via the network 18. The WAD 12 receives and executes the web page document. The execution of script in the web page document by the WAD 12 can result in generation of a display 28 that includes the secure URL.

As shown in FIG. 1D, the WAD 20 can generate a signal including a URL with access right data to request access to a resource designated by the URL. The signal can be generated by the WAD 12 automatically as it executes script in the web page document. Alternatively, the WAD 12 can generate the signal including the URL with secure resource access right data in response to operation of the input device 22 by the user of the WAD 12, such as by “clicking” or activating a hyperlink for the URL using the input device 22. The signal requesting access to the resource designated by the URL, including the URL with secure resource access right data, is transmitted by the WAD 12 to the RDS 16 via the network 18 using the URL to address the web server 30.

The RDS 16 can include a web server 30 and a data storage unit 32. The web server 30 is coupled to receive the signal requesting access to the resource that includes the URL, data fields indicating a file path to the data storage location of the resource, and the resource access right data that defines the rights of the WAD and/or user to access the resource in a secure manner which prohibits tampering with such data. The web server 30 stores key data used to verify that the WAD 12 is permitted to access a resource based on the resource access right data. This key data can be a shared key or public/private key pair, for example. The web server 30 uses the key data to decrypt or match hash data within the resource access right data or derived therefrom to verify that the WAD and/or user is authorized to access a resource. The resource access right data serves to limit or restrict the ability of a WAD and/or use to access the resource. The web server 30 determines the resource access right(s) of the WAD 12 and/or the user of the WAD, based on the decoded resource access right data. If the web server 30 determines that the decoded resource access right data does not authorize the WAD 12 and/or the user of the WAD to access the resource, the web server 30 can generate and transmit a signal indicating denial of access to the WAD via the network 18. The WAD 12 can generate a display indicating denial of access to the resource based on the denial-of-access signal from the web server 30. Conversely, if the web server 30 determines that access to the resource is permitted based on the decoded resource access right data, the web server 30 determines whether the data storage unit 32 includes the requested resource. If the resource is not present in the data storage unit 32, the web server 30 generates a signal to request the resource from the resource provider subsystem 14. In this case, the web server 30 transmits the request-for-resource signal to the web server 24 of the resource provider subsystem 14, as shown in FIG. 1E.

The web server 24 is coupled to receive the request-for-resource signal from the RDS 16 via the network 18. The web server 24 retrieves the resource from the data storage unit 26 using the URL and file path in the signal received by the RDS 16 from the WAD's signal. The web server 24 encodes and transmits the resource data to the web server 30 of the RDS 16. The web server 24 can encrypt the resource data using key data so that the resource data is secure in transmission to the RDS 16. The web server 24 generates and transmits a signal including the resource data to the web server 30 of the RDS 16 via the network 18, as shown in FIG. 1F.

Still referring to FIG. 1F, the web server 30 of the RDS 16 is coupled to receive the signal including the resource data from the resource provider subsystem 14 via the network 18. The web server 30 executes its operating system and/or an application program to decode the resource data. The web server 30 can decrypt the resource access right data using key data corresponding to the requested URL. The web server 30 stores the resource data in the data storage unit 32. If the resource data is in the form of text, or one or more images, or one or more applets, in a web page document, for example, the web server 30 can transmit the resource data to the WAD 12 via the network 18, as shown in FIG. 1G. Optionally, the web server 30 can encrypt the resource data before transmission to the WAD 12. The WAD 12 can be coupled to receive the resource data signal from the network 18. The WAD 12 can execute script in the web page document to generate a display with display unit 20, based on the resource data. Conversely, if the resource is a server application, the web server 30 can load and execute the server application(s) to generate signals exchanged with the WAD 12 via the network 18 to permit the user of the WAD to use the server application resource.

FIGS. 2A-2E are views of a method for accessing a resource via the WAD 12 in which the resource has been stored on the data storage unit 32 of the RDS 16 before execution of the method. The resource may have been stored in the data storage unit 32 as a result of previous performance of the method of FIGS. 1A-1G, or alternatively, may have been physically sent by mail or transmission over the network 18 along with the key data and stored in the web server 30 and data storage unit 32 to prepare the RDS 16 for performance of the method of FIGS. 2A-2E.

In FIG. 2A, the RDS 16 is provisioned with key data stored in the RPS 14. The key data permits the web server 24 to secure resource access right data so that it cannot be changed or tampered with by a user of the WAD 12. The resource access right data can thus be controlled by the RPS 14 even though RDS 16 is used to remotely distribute the resource. The key data further permits the web server 30 to authenticate and verify the WAD's and/or user's request to access the resource as well as to determine the rights of such WAD and/or user has to use the resource. In FIG. 2B, the WAD 12 generates a signal requesting a web page document from the RPS 14. The WAD 12 transmits the signal requesting the web page document to the RPS 14 via the network 18. The RPS 14, or more specifically, the web server 24, is coupled to receive the request for the web page document from the WAD 12. The web server 24 of the RPS 14 retrieves the web page document(s) from the data storage unit 26. The web server 24 finds URL(s) within the web page document, and retrieves resource access right data for the URL(s). The web server 24 can retrieve the resource access right data based on the URL(s), as well as the identity of the user and/or the identity of the WAD 12, for example. The web server 24 encodes the resource access right data using key data stored in such web server, and combines the resource access right data with the secure URL(s) in the web page document. Alternatively, the RPS 14 can retrieve data including one or more URLs from the data storage unit 26 using the WAD's IP address and/or identity of the user of the WAD. The RPS 14 can retrieve secure resource access right data for the IP address and/or user identity from its data storage unit 26. The RPS 14 can perform a hash of all or a portion of the resource access right data, and can combine the secure URL(s) with data for the web page retrieved from the data storage unit 26. The RPS 14 can combine the secure resource access right data with respective URL(s) to generate secure URL(s). The web server 24 can further retrieve data from the data storage unit 26, and can assemble such data with the secure URLs to generate a web page document with secure URLs designating the IP address and file path of a resource and the requesting WAD's or user's rights with respect thereto. The web server 24 transmits the web page document including the URL(s) with secure resource access right data to the WAD 12. The WAD 12 is coupled to receive the web page document having the secure URL(s) with the resource access right data. The WAD 12 can generate a display 28 on the unit 20 based on the web page document having the URL(s) with secure resource access right data, as shown in FIG. 2C.

In FIG. 2D the WAD 12 generates a signal requesting access to a resource indicated by the URL(s) with resource access right data. This signal can be generated automatically by the WAD 12 in the execution of script included in the web page, or by the operation of the input device 22 to cause the WAD 12 to generate the signal. The WAD 12 transmits the signal requesting access to the resource with the URL(s) with respective secure resource access right data, to the web server 30 of the RDS 16. The web server 30 is coupled to receive the signal requesting access to the resource from the WAD 12 via the network 18. The web server 30 decodes the secure URL, and retrieves key data for the secure URL and/or IP address of the WAD from its memory. The web server 30 can check the secure URL for proper formatting of data fields. The web server 30 uses the key data to authenticate the IP address of the WAD 12. In addition, the web server 30 verifies the integrity of the secure resource access right data by either decrypting such data or performing a hash operation and matching the resulting hash to one inserted in the secure URL string by the RPS 14. The web server 30 determines whether the WAD 12 and/or user of the WAD is authorized to access the resource, based on the secure resource access right data received from the WAD 12. If the web server 30 determines that the user and/or WAD 12 is not authorized to access the resource, the web server 30 can generate and transmit a denial of access signal to the WAD 12 via the network 18. The denial-of-access signal can be used to generate a display 28 on the unit 20 to indicate that the user and/or WAD 12 is not authorized to access the resource. Conversely, if the web server 30 determines that the user of the WAD 12 and/or the WAD is authorized to access the resource, the web server 30 retrieves the resource from the data storage unit 32. The web server 30 can use a field path to determine the data storage location of the resource. If the resource is data such as text, image(s), or applet(s), the web server 30 generates a signal including the resource data and transmits such resource data to the WAD 12 via the network 18, as shown in FIG. 2E. If the resource is a server application, the web server 30 loads and executes the server application. The web server 30 can execute the loaded server application to generate a signal(s) exchanged with signal(s) of the WAD 12 to permit the user of the WAD to interact with the web server 30 over the network 18, as shown in FIG. 2E.

### 3. Web Access Device and Related Methods

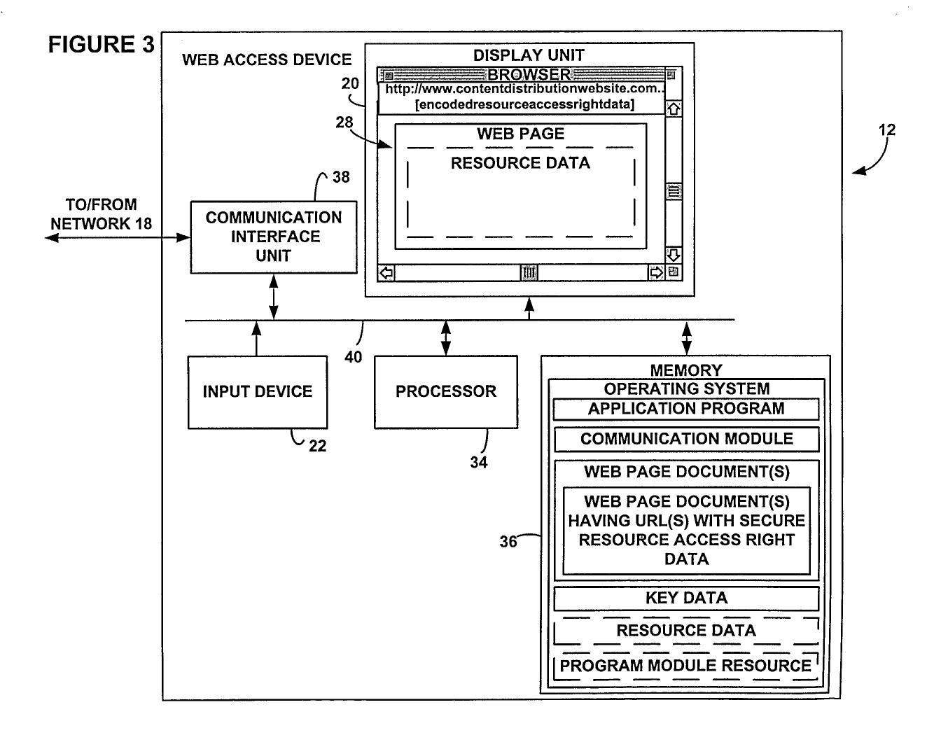

FIG. 3 is a view of an exemplary embodiment of the WAD 12. The WAD 12 can include a display unit 20, and input device 22, a processor 34, a memory 36, and communication interface unit 38, coupled to the bus 40. The communication interface unit 38 is additionally coupled to communicate with the network 18 through optical or electronic transmission media, or through transmission/reception of wireless signals.

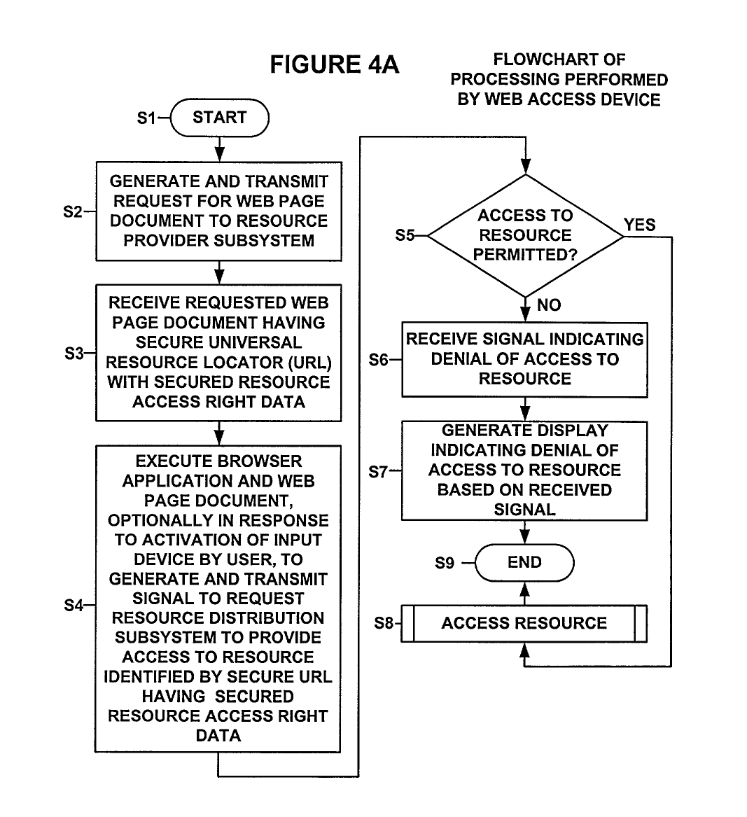

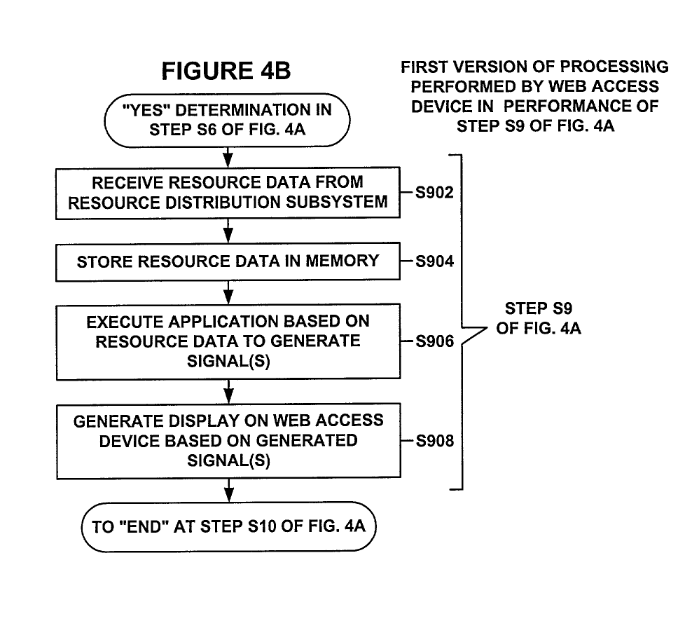

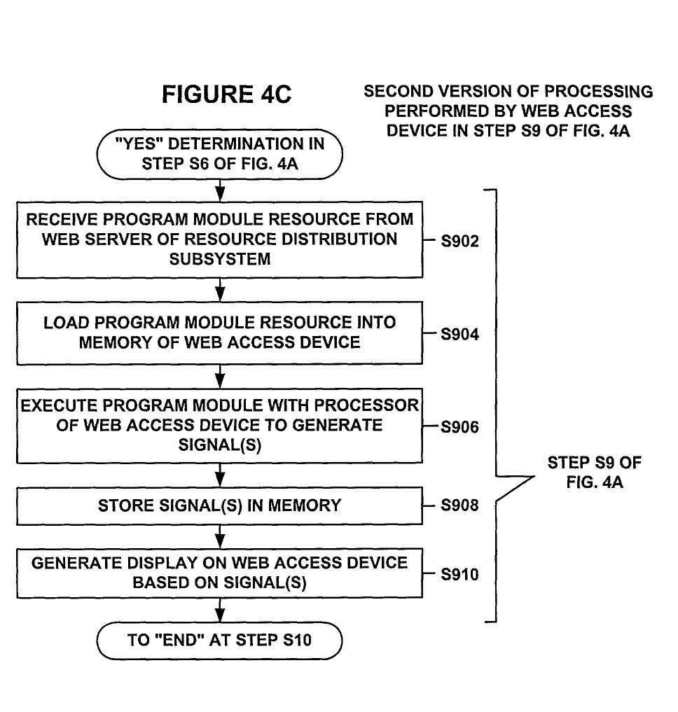

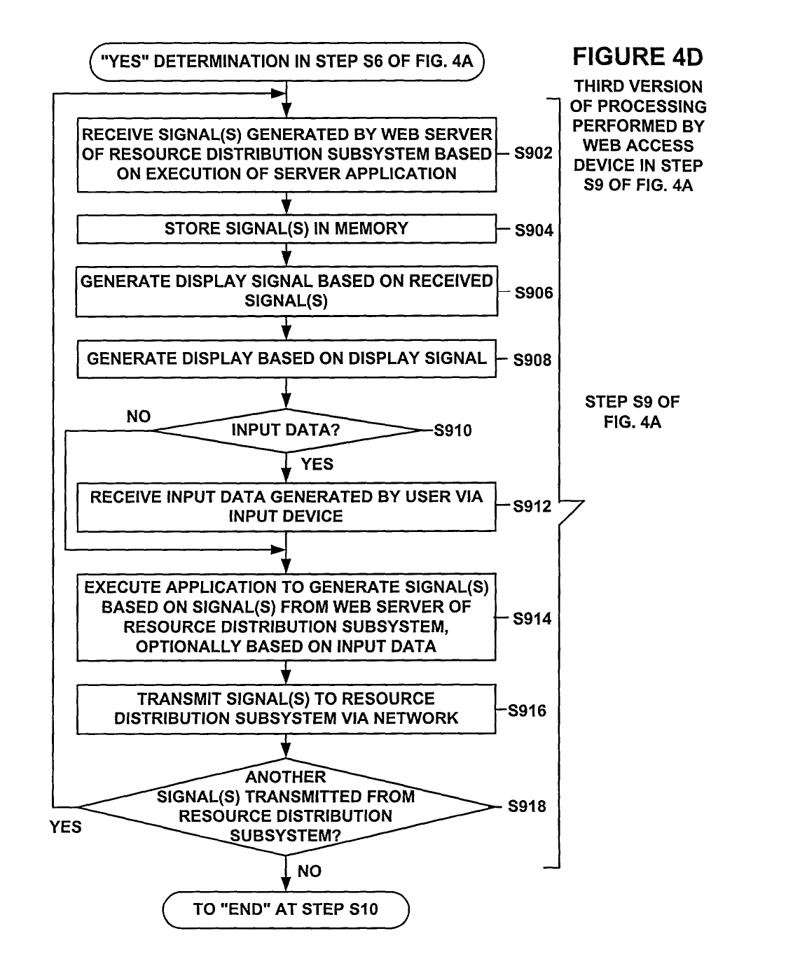

FIG. 4A is a flowchart of processing performed by the processor 34 of the WAD 12. In step S1 the method of FIG. 4A begins. In step S2 the WAD 12 generates and transmits a signal requesting a web page document from the RPS 14. More specifically, the WAD 12 executes a browser application program stored in the memory 36. Based on execution of the browser application program, the processor 34 generates a display signal supplied to the unit 20 via the bus 40. The display unit 20 generates a display 28 based on the execution of the browser application. The browser application may be such as to cause the processor 34 to automatically generate a hypertext transfer protocol (HTTP) signal to request access to the URL designating the RPS 14. Alternatively, the user of the WAD 12 can operate the input device 22 to input the URL of the RPS 14 and to cause the processor 34 to generate the HTTP message to the RPS via the network 18. The communication interface unit 38 is coupled to the processor 34 to receive the HTTP signal requesting a web page document hosted by the RPS 14, as indicated by the URL included in the HTTP message. The communication interface unit 38 transmits the HTTP message to the web server 24 via the network 18. Optionally, the processor 34 can encrypt the HTTP message using key data previously programmed into the memory 36, or previously established through a log-in procedure to initiate a session with the RPS 14. The HTTP message requesting the web page document from the RPS 14 can be transmitted in transfer control protocol/internet protocol (TCP/IP) over the network 18.

In step S3 of FIG. 4A, the WAD 12 receives a signal including the requested web page document. More specifically, the WAD 12 receives a web page or hypertext mark-up language (HTML) document including the URL with the resource access right data. The WAD 12 receives the web page document as a signal from the network 18 at the communication interface unit 38. The processor 34 coordinates transfer of the web page document from the communication interface unit 38 to the memory 36 via the bus 40. The processor 34 executes the browser application and the web page document to generate a display signal supplied to the display unit 20. The display unit 20 generates the display 28 of the browser and web page document based on the display signal from the processor 34.

In step S4 of FIG. 4A the WAD 12 executes the browser application and web page document, optionally in response to activation of the input device 22, to generate the signal to request access to the resource identified by the URL with resource access right data included in the web page document. The processor 34 of the WAD 12 can execute the browser application and script in the web page document to generate the signal to request access to the resource identified by the URL with the resource access right data. The processor 34 can generate the signal requesting access to the resource as an HTTP message. The processor 34 of the WAD 12 supplies the HTTP message having the URL with the secure resource access right data to the communication interface unit 38 that transmits the HTTP message to the RDS 16 via the network 18.

In step S6 of FIG. 4A the RPS 16 determines whether access to the resource is permitted to the user and/or WAD 12. If not, the RPS 16 generates and transmits a signal indicating denial of access to the resource to the WAD 12 via the network 18. In step S7 the WAD 12 receives the signal indicating denial of access to the resource. In step S8 the WAD 12 generates a display 28 indicating denial of access to the user of the WAD.

Conversely, if in step S6 of FIG. 4A the RDS 16 determines that access to the resource is permitted, the WAD 12 can access the resource in step S9. After performance of steps S8 or S9, processing performed by the processor 34 by executing its browser application and/or web page document ends in step S10.

The flowcharts of FIGS. 4B, 4C, and 4D correspond to step S8 of FIG. 4A, namely, providing access to the resource, for different types of resources that can be hosted by the RDS. The flowchart of FIG. 4B relates to processing performed by the processor 34 of the WAD 12 in the case in which the resource is data such as text, image(s) in a web page document, for example. In step S902 of FIG. 4B the WAD 12, or more specifically, the processor 34, receives the resource data from the RDS 14 via the network 18. The processor 34 can receive the resource data from the network via the communication interface unit 38. More specifically, the communication interface unit 38 receives the resource data from the web server 30 of the RDS 14, and supplies the resource data to the processor 34 via the bus 40. In step S904 of FIG. 4B the processor 34 stores the resource data in the memory 36 via the bus 40. In step S906 the processor 34 executes the application program stored in the memory 36 based on the resource data to generate a signal(s). In Step S908 the processor 34 generates the display 28 on the WAD 12 based on the signal(s) generated in step S906. After performance of step S908 processing proceeds to and terminates in step S10 of FIG. 4A.

The flowchart of FIG. 4C indicates processing performed by the processor 34 in a case in which the resource is a downloadable program module. After an affirmative determination in step S6 of FIG. 4A, the processor 34 receives the program module resource from the web server 30 of the RDS 16. More specifically, the communication interface unit 38 receives the program module from the web server 30 via the network 18. The communication interface unit 38 transmits the program module to the processor 34 via the bus 40. In Step S904 the processor 34 loads the program module resource into the memory 36. The WAD 12 executes the program module with the processor 34 of the WAD 12. In step S906 the processor 34 executes the program module to generate a signal(s). In step S908 the signal(s) can be stored in the memory 36 of the WAD 12. In step S910 the processor 34 generates the display 28 on the unit 20 based on the signal(s). After performance of processing of FIG. 4C, processing performed by the processor 34 proceeds to and terminates in step S10.

FIG. 4D is a flowchart of processing performed by the processor 34 in a case in which the resource is a client application. After determining that the WAD 12 is authorized to access the server application in step S6 of FIG. 4A, the processor 34 receives signal(s) generated by the web server 30 of the RDS 16 by execution of the server application in step S902 of FIG. 4D. More specifically, the communication interface unit 38 receives the signal(s) from the web server 30 via the network 18, and transmits the received signal(s) to the processor 34 via the bus 40. In step S904 of FIG. 4D the processor 34 stores the decoded signal(s) in the memory 38 via the bus 40. In step S906 the processor 34 generates a display signal based on the signal(s) from the web server 30. In step S908 the processor 34 generates the display 28 based on the display signal. In step S910 the processor 34 determines whether input data has been generated by the user via the input device 22. If so, in step S912, the processor 34 receives input data generated by the user via the input device 22. After a negative determination in step S910 or performance of step 912, the processor 34 executes the application program stored in the memory 36 to generate a signal(s) based on the signal(s) received from the web server 30 and optionally also the input data generated by the user. In step S916 of FIG. 4D the processor 34 transmits the signal(s) generated in step S908 to the RDS 16 via the network 18. In step S918 the processor 34 determines whether another signal(s) has been received from the web server 30. If so, processing performed by the processor 34 returns to step S902. Conversely, if the determination in step S918 is negative, processing performed by the processor 34 proceeds to and terminates in step S10 of FIG. 4A.

### 4. Resource Provider Subsystem (“RPS”) and Related Methods

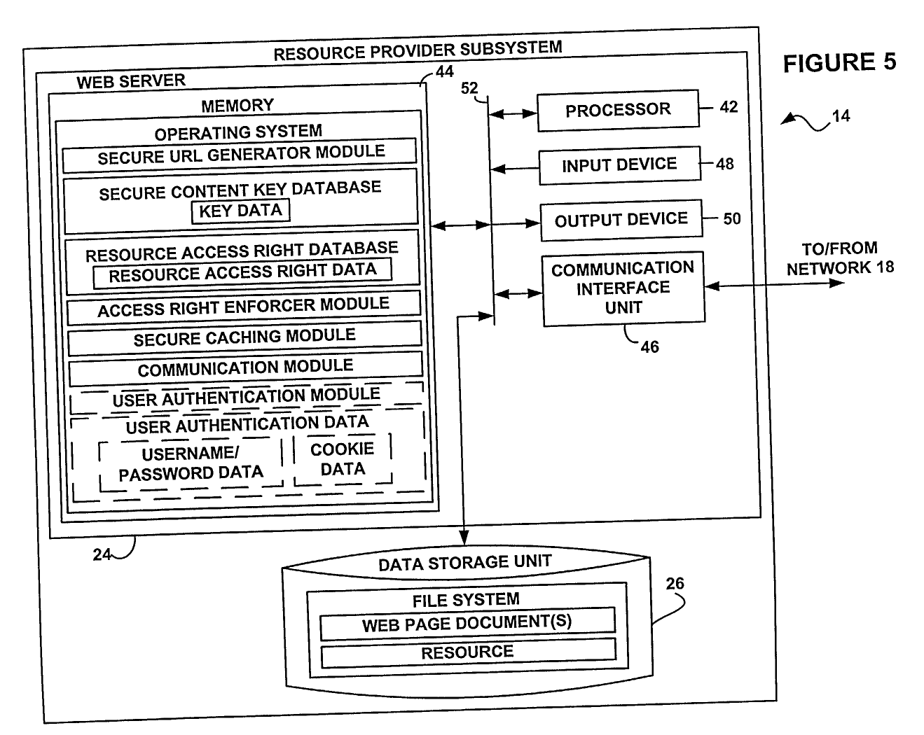

The RPS 14 is shown in relative detail in FIG. 5. The RPS 14 includes the web server 24 and the data storage unit 26. The web server 24 includes a processor 42, a memory 44, a communication interface unit 46, input device 48, and output device 50, coupled to bus 52. The communication interface unit 46 is coupled to the network 18 through wire, optical fiber, or wireless transmission media. The processor 42 is coupled to the data storage unit 26 via the bus 52.

The memory 44 can store an operating system that permits the processor 42 to communicate with the memory 44, communication interface unit 46, the input device 48, the output device 50, and the data storage unit 26, via the bus 52. The memory 44 stores various program modules containing computer code executed by the processor 42 to perform various functions in coordination with the operating system. More specifically, the memory 44 stores a secure URL generator module, an access right enforcer module, a secure caching module, a communication module, and optionally a user authentication module. The memory 44 also stores a secure resource key database that includes key data and resource access right data. Furthermore, the memory 44 can store user authentication data including username/password data in which case the user authentication module performs the functions of the session layer in the ISO/OSI model IEEE specifications. The secure URL generator module is executed in response to a request signal from the WAD 12 requesting a web page document. The request signal can be initially handled by the communication module that manages reception and transmission of signals over the network 18 in coordination with the operating system. The secure URL generator module is executed by the processor 42 to retrieve the requested web page document, and to find any URL(s) within the web page document. The secure URL generator module retrieves key data and resource access right data for the URL(s) from the secure resource key database. The secure URL generator module secures the resource access right data using the key data. If more than one key is used in the system 10, the secure URL generator module can also append key index data indicating the key to be used by the RDS 16 to verify a request to access the resource from the WAD 12. The secure URL generator module combines the resource access right data with its corresponding URL in the web page document. The secure URL generator module calls the communication module that handles transmission of the web page document having URL(s) with resource access right data, to the WAD 12. The access right enforcer module is launched by processor 42 upon receiving a resource request signal from the RDS 16. The access right enforcer module determines whether the RDS 16 is authorized to receive the requested resource. If so, the access right enforcer module calls the secure caching module that retrieves the resource from the data storage unit 26 and retrieves key data corresponding to the RDS requesting the resource. The secure caching module encodes the resource with the key data, and calls the communication module to transmit the encrypted resource to the requesting RDS. The communication module generates a signal including the encrypted resource and transmits such encrypted resource to the communication interface unit 46 for transmission to the RDS 16. The input device 48 and output device 50 can provide a graphical user interface (GUI) in connection with a server program (not shown) that permits an operator of the web server 44 to perform administrative tasks such as loading or updating the operating system and various program modules, web page document(s), data, and resource(s) stored in the memory 44 and the data storage unit 26.

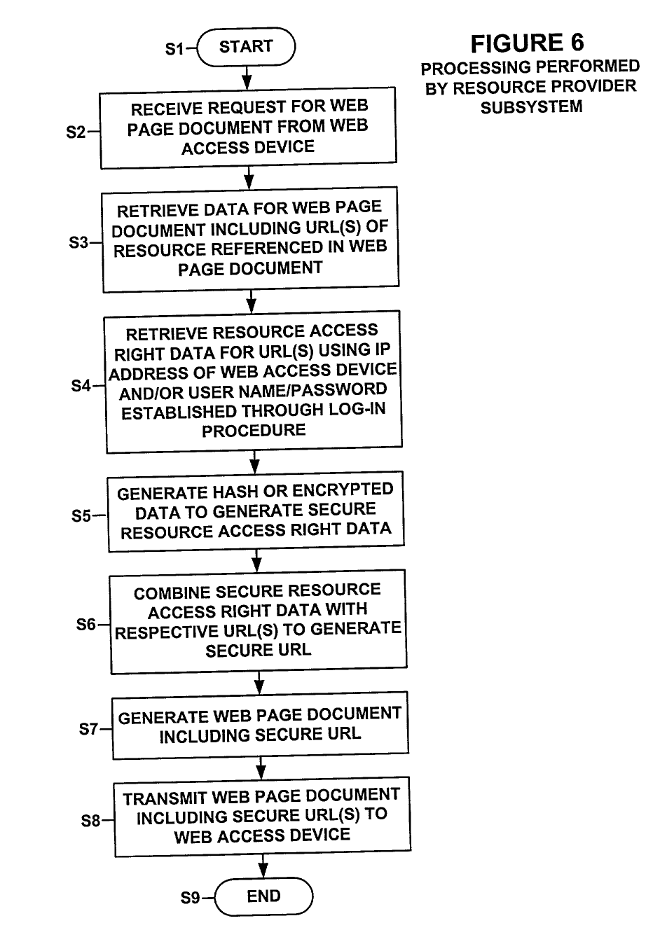

FIG. 6 is a flowchart of processing performed by the RPS 14. In step S1 the method of FIG. 6 begins. In step S2 the processor 42 of the RPS 14 receives an HTTP request for a web page document from a WAD 12 via the network 18. The processor 42 executes the communication module stored in the memory 44 to perform the message handling necessary to receive the request from the WAD 12 via the network 18. In step S3 the processor 42 of the RPS 14 executes the secure URL generator module to retrieve from its memory 44 data for the requested web page document including URL(s) and data path(s) of the respective resource(s) referenced in the web page document. In step S4 the processor 42 executes the secure URL generator module to retrieve resource access right data for URL(s) using an IP address of a WAD 12 and/or user name and password established by a log-in procedure through execution of the session layer in the ISO/OSI model. In step S5 the processor 42 executes the secure URL generator module to retrieve key data from its memory 44. The processor 42 executes such module to generate hash or encrypted data from a portion of the URL, which generally includes the IP address of the WAD 12 and possibly other data as well. The processor 42 further executes the secure URL generator module to combine with resource access right data. In step S6, through execution of the secure URL generator module, the processor 42 combines the secure resource access right data with the URL(s) to produce a secure URL(s), and encodes the resulting secure URL into a form readable by the WAD 12 or server 30 of RDS 16. In step S7 the processor 42 executes the secure URL generator module to generate a web page document including secure URL(s). In step S8 the processor 42 executes the communication module to transmit the web page document including the secure URL(s) to the WAD 12 via the network 18. In step S9 the method of FIG. 6 ends.

### 5. Resource Distribution Subsystem (“RDS”) and Related Methods

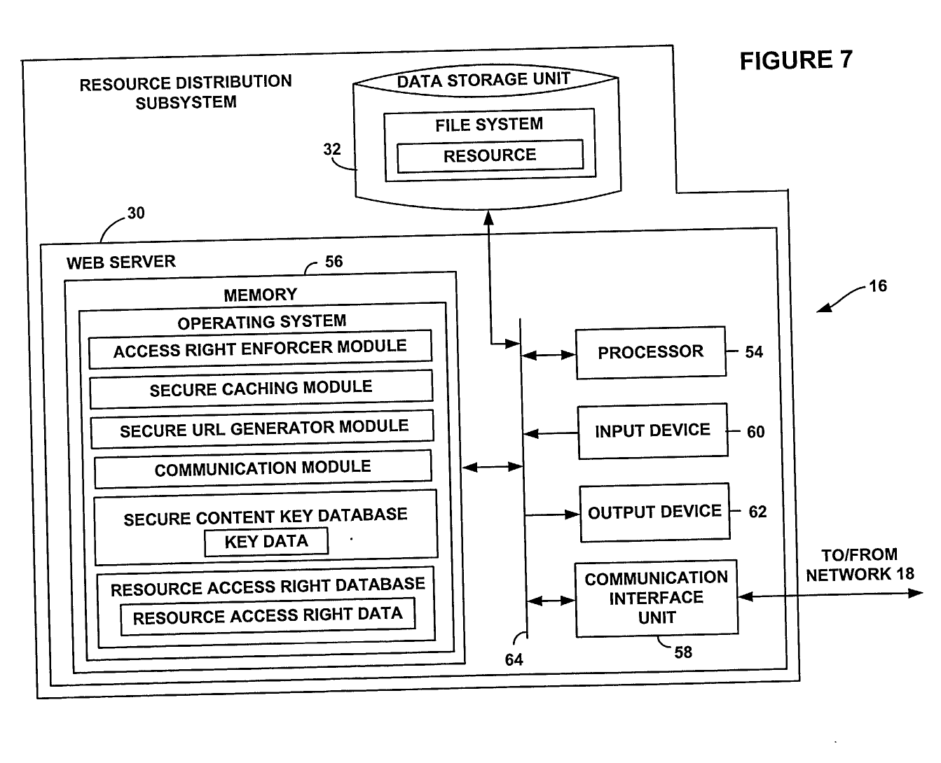

In FIG. 7 the RDS 16 is shown in relative detail. As previously described, the RDS 16 includes a web server 30 and a data storage unit 32. The web server 30 includes a processor 54, a memory 56, a communication interface unit 58, an input device 60, and an output device 62. The memory 56 stores an operating system that is loaded and executed by the processor 54 to enable such processor to receive and transmit signals from and to the memory 56, the communication interface unit 58, the input device 60, the output device 62, and the data storage unit 32 via the bus 64. The memory 56 also stores various program modules that the processor 42 executes in coordination with the operating system to control access to a resource requested by the user and/or WAD 12. More specifically, the memory 56 stores an access right enforcer module, a secure caching module, a secure URL generator module, and a communication module. The RDS 16 also stores a secure content key database storing key data, and a resource access right database storing access right data that defines the rights and limits of a WAD and/or user to access a resource. The communication module is executed by the processor 54 to receive a request-for-resource signal including a URL with secure resource access right data from the WAD 12 via the network 18. The signal can be received by the communication interface unit 58 using TCP/IP protocol, for example. The processor 34 receives such request signal from the communication interface unit 58 over the bus 64 through execution of the communication module and operating system program. The access right enforcer module is executed by the processor 54 to determine whether a user is authorized to access a resource designated in a request signal from a WAD 12. The processor's execution of the access right enforcer module causes such processor to generate a control signal supplied over the bus 64 to retrieve key data from the memory 56. The processor 54 receives the key data from the memory over the bus 64, and uses the key data to verify the hashed or encrypted portion of the access right data contained in the request-for-resource signal from the WAD 12. If the processor 54 determines that the user is not authorized to obtain the resource based on the decoded access right data, the processor 34 generates and transmits a denial-of-access signal to the WAD 12 by executing the communication module and operating system program to transmit such signal. More specifically, the processor 54 generates the denial-of-access signal and supplies such signal to the communication interface unit 58 over the bus 64. The processor 54 can generates the denial-of-access signal as an HTTP message that can be a standard “403 Forbidden” message, for example. The communication interface unit 58 transmits the denial-of-access signal to the WAD 12 over the network 18.

The secure caching module is executed by the processor 54 to retrieve a resource if the execution of the access right enforcer module determines that access to the resource is permitted for the requesting WAD and/or user. The processor 54 generates a signal supplied to the data storage unit 32 via the bus 64. If the resource is present in the data storage unit 32, the processor 54 retrieves the resource via the bus 64. Depending upon the nature of the resource, the processor 54 can load and execute the resource using its memory 56. The execution of such resource may cause generation of signals that are supplied to the WAD 12 via the network 18 using the communication interface unit 58 through execution of the communication module and operating system program. Alternatively, the resource can be data in which case the processor 54 executes its communication module and operating system program to supply such data to the WAD 12 via the communication interface unit 58 and network 18.

Conversely, if the resource is not present in the data storage unit 32, the processor 54 executes the secure caching module to generate a request-for-resource signal. The processor 54 supplies the request-for-resource signal to the communication interface unit 58 over the bus 64. The execution of the communication module and operating system program by the processor 54 causes such signal to be supplied to the communication interface unit 58. The communication interface unit 58 transmits the request-for-resource signal to the RPS 14. The unit 58 can transmit the request-for-resource signal in TCP/IP protocol, for example. In response to the request-for-resource signal, the RPS 14 determines if the RDS 16 is authorized to host the resource. If not, the RPS 14 generates and transmits a denial-of-request-for-resource signal over the network 18 to the web server 30 of RDS 16. Conversely, if the RPS 14 determines that the RDS 16 is authorized to access the resource, the RPS 14 can encrypt the resource with key data pre-established for signals transmitted between the RPS 14 and the RDS 16. The RPS 14 transmits the resource signal to the RDS 14 via the network 18. The resource signal can be transmitted by the web server 24 in TCP/IP protocol. The RDS 16 receives the resource signal at the communication interface unit 58. The processor 54 executes the communication module and operating system program to receive the resource signal from the communication interface unit 58 via the bus 64. The processor 54 retrieves key data appropriate for the RPS 14 from the memory 56 via the bus 64. The processor 54 executes the secure caching module to decrypt the resource signal with the key data. The processor 54 transmits the decoded resource signal to the data storage unit 32 for storage. As previously described, the resource can be such as to be loaded and executed by the processor 54, or may be interactive in nature such as a server application that interacts with a client application of the WAD 12. Alternatively, the resource can be a data file that is transmitted by the processor 54 to the WAD 12. The resource or signals derived therefrom can be encrypted before transmission and decrypted after receipt by the processor 54 and the WAD 12 so that the resource or signals derived therefrom are not exposed to hacking or theft in transit over public network 18.

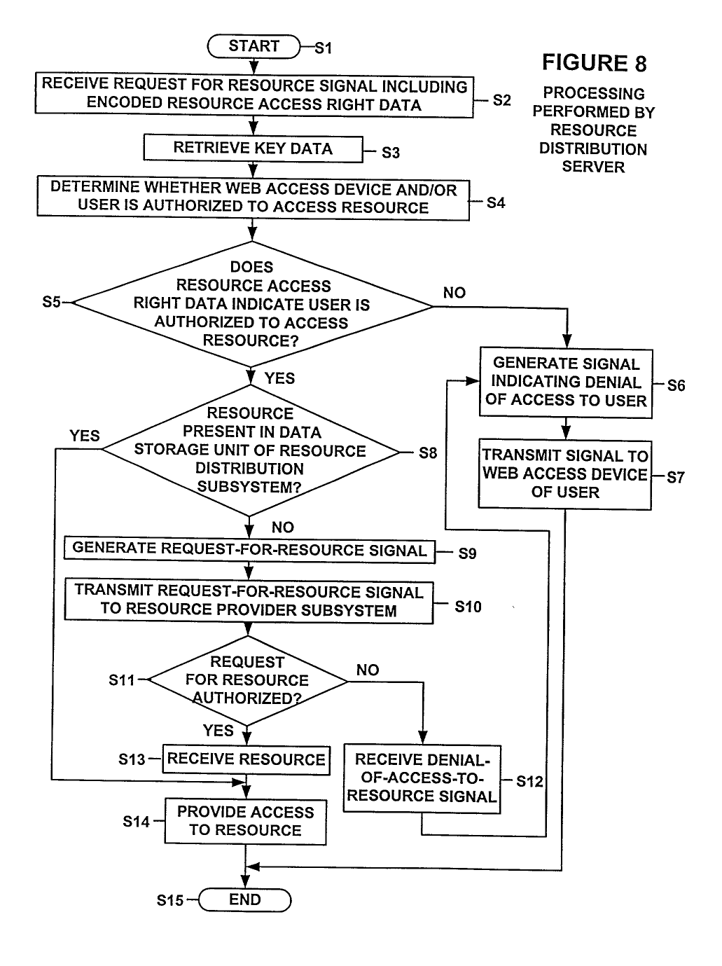

FIG. 8 is a flowchart of processing performed by the web server 30, or more specifically, the processor 54. In FIG. 8 processing performed by the processor 54 begins in step S1. In step S2 the communication interface unit 58 receives the request-for-resource signal having the URL and secure resource access right data from the WAD 12 via the network 18. The processor 54 executes the communication module and operating system program to receive the request-for-resource-access signal from the communication interface unit 58 via the bus 64. In step S3 the processor 54 executes the access right enforcer module, which causes such process to retrieve key data from the secure content key database of the memory 56 using the bus 64. In step S4 the processor 54 uses the key data to determine whether the WAD and/or user is authorized to access the resource using the resource access right data in the request-for-access signal from the WAD 12. In step S5 the processor 54 determines whether the resource access right data indicates that the user is authorized to access the resource. If not, in step S6 the processor 54 generates a signal indicating denial of access to the WAD 12. In step S7 the processor 54 executes the communication module to transmit the denial-of-access signal to the WAD 12. Conversely, if in step S5 the processor 54 determines that the WAD 12 is authorized to access the resource, in step S8 the processor 54 executes the secure caching module to determine whether the resource is present in the data storage unit 32. If not, in step S9 the processor 54 executes the secure caching module to generate a request-for-resource signal. In step S10 the processor 54 executes the communication module and operating system program to transmit the request-for-resource signal to the communication interface unit 58 via the bus 64. The communication interface unit 58 transmits the request-for-resource signal over the network 18 to the RPS 14. In step S11 the web server 24 of the RPS 14 determines whether the RDS 16 is authorized to receive the resource. If not, the web server 26 generates a denial-of-access-to-resource signal and transmits such signal to the RDS 16 via the network 18. In step S12 the processor 54 receives the denial-of-access-to-resource signal. Conversely, if the web server 24 of the RPS 14 determines that access to the resource is authorized, such web server retrieves the resource from the data storage unit 26. The web server 24 executes its access right enforcer module, causing such web server to retrieve key data from the secure content key database in the memory 44. The web server 24 uses the key data to encrypt the resource, and transmits the encrypted resource signal to the web server 30 of the RDS 16 via the network 18. The communication interface unit 58 receives the resource signal from the network 18. In step S13 the processor 54 executes the communication module and operating system program to receive the resource data from the communication interface unit 58 via the bus 64. After an affirmative determination in step S8 or after performance of step S13, in step S14, the processor 54 provides access to the resource for the WAD 12. The manner of providing access to the resource depends upon its nature. If the resource is an application, such access can be provided by loading and executing such resource application with the processor 54 of the web server 30. Alternatively, if the resource is data, the resource can be provided by the processor 54 to the WAD 12 via transmission over the network 18. After performance of step S7 or step S14, processing performed by the processor 54 terminates in step S15 of FIG. 8.

### 6. Secure Content Key Database

The secure content key database is a data table or file hosted on the RPS 14 and/or RDS 16, or more specifically, the respective web servers 24, 30. The secure resource key database can be pre-defined initially and updated through secure signals transmitted from the web server 24 to the web server 30.

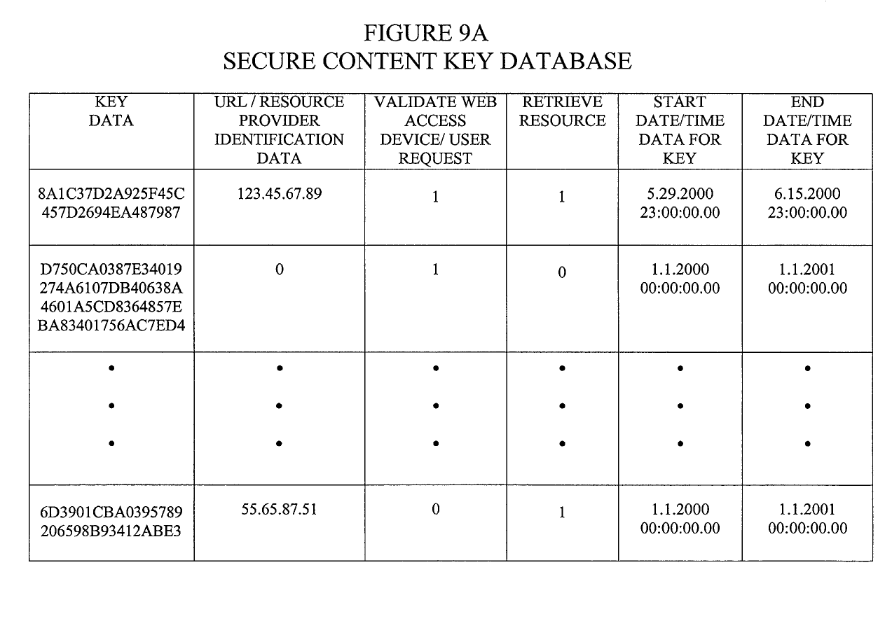

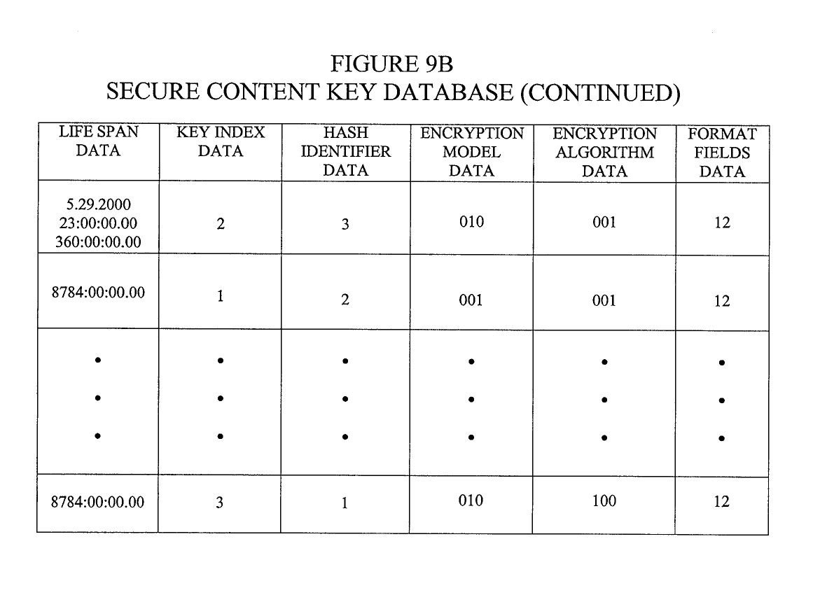

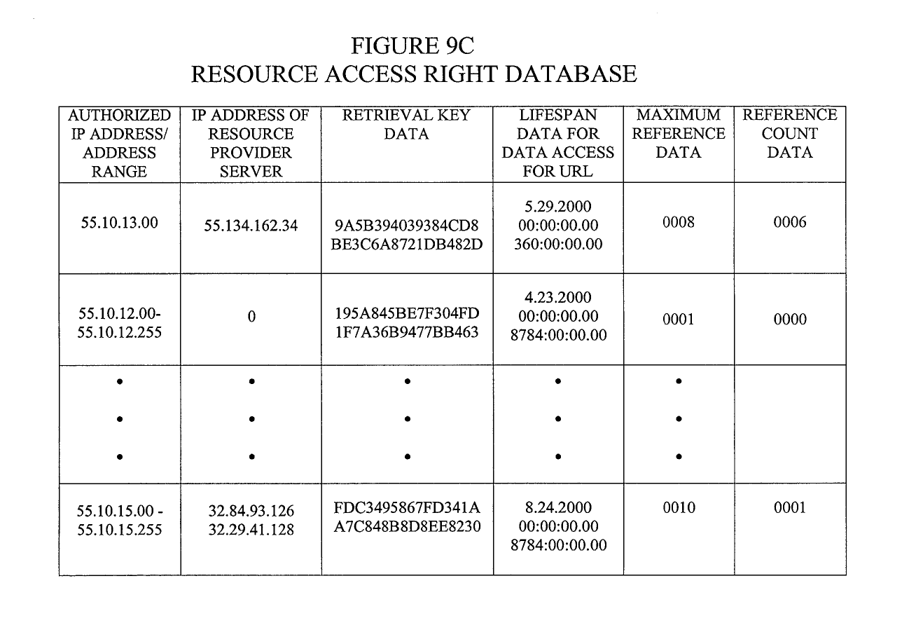

As shown in FIGS. 9A and 9B the database contains a list of one or more rows of data or records. The fields or columns and values associated with the data records are identified below.

Key Data

Each row or record includes hash and/or encryption/decryption key data associated with a resource provider. The key data can be a 128-bit or 256-bit key, for example, which are industry standard key sizes. The encryption key data is indicated in hexadecimal format, i.e., binary numbers 0000-1111 correspond to hexadecimal numerals 0-F.

URL/Resource Provider Identification Data

It is possible that the web servers 24, 30 host resources of more than one resource provider on the network 18. Accordingly, the resource provider identification data permits the web servers 24, 30 to identify and distinguish between different resource providers. For example, the web server 30 can use the URL of a resource provider to retrieve a resource from such provider in the event the web server 30 determines that it does not already host the resource. A “0” value in this field can be used to indicate that the web server 30 hosts the resource.

Validate Web Access Device/User Request

This field identifies to the web servers 24, 30 whether the key is to be used to validate a WAD/user request. If this value is set to “1” the key is used to validate requests from the WAD 12, and if the value is set to “0” the key is not used to validate requests.

Retrieve Resource Data

This field is used to indicate to the web servers 24, 30 whether its associated key data is for use in retrieving a resource from respective data storage units 26, 32. If the value of this field is set to “1” then the associated key data is used to validate a request to retrieve a resource. Conversely, if this value is “0” then the associated key data is not used to validate such request.

Start Date/Time Data

This field indicates the start date and time over which corresponding key data is valid. For example, the format of the field can be “month.day.year” to specify the date, and “hour.minute.tenth-of-second.hundredth-of-second” to specify the time. Accordingly, “5.29.2000” means “May 29, 2000” and “23:00:00.00” means “11:00:00.00PM.” Such start date/time data can alternatively be represented in “epoch time” which is well-known to those ordinary skill in the art, and refers to the number of seconds elapsed since the beginning of Jan. 1, 1970.

End Date/Time Data

This field indicates the end date and time beyond which the key data is no longer valid. The format of the field can be similar to that of the “Start Date/Time Data” field.

The Start Date/Time Data and End Date/Time Data fields can be used to define a time period over which the key data is valid. Subscriptions to a resource can use key data valid for limited periods of time.

Lifespan Data

This field can be used to determine the lifespan of its associated key. The lifespan data can be defined as a certain length of time from a particular start date/time. Hence, in this example, the lifespan data can be defined as the start date/time data “5.29.2000 23:00:00.00” and lifespan data of “360:00:00.00”.

Key Index Data

This field identifies the index associated with its corresponding key data. It identifies keys used to control access to a distributed resource. This field can be set to a value within the range of values for all keys recognized for communication between the WAD 12 and the RPS 14 and/or RDS 16. This field can also be set to “0” to indicate that the associated key is the only key used to control and secure resource access in communications between the WAD 12 and the RPS 14 and/or RDS 16. For example, upon receiving a request for access to a resource, the web server 30 of RPS 16 can use the key index data in the request signal to retrieve the appropriate key for use in validating the request. Alternatively, the RPS 16 can use a single key to validate each resource request, in which case no key index need be specified in the request signal.

Has Identifier Data

This field identifies a hash algorithm utilized by the WAD 12 and/or web servers 24, 30 to communicate with one another by signals transmitted over network 18. As previously described, the hash algorithm can be one of many different algorithms including SHA-1 published by the United States Government, MD5 (Message Digest Algorithm 5) produced by RSA Laboratories, Inc, Tiger, RIPEMD-160, DES, 3-DES, and others. A hash algorithm generally has the properties that: (1) different data do not map to the same digest upon application of a digest algorithm; and (2) the digest does not reveal anything about the particular digest algorithm or data that was used to generate it. In addition, many digest algorithms generate a fixed length data string regardless of the number of bits in the hashed data. This feature generally permits the hashed data to be more readily incorporated into a message format for transmission as a signal by the WAD 12, the web server 24, and/or the web server 30 over the network 18.

Encryption Model

This field indicates the encryption strategy to be used to generate encrypted resource access right data. For example, the encryption strategy can be one-way, two-way, etc.

Encryption Algorithm

This field identifies the encryption algorithm to be used to generate encrypted resource access right data. The encryption algorithm can be public key/private key or private key algorithms which are well-known to those of ordinary skill in this technology.

Format Fields

This field indicates the number of format fields contained in a data record of the database. It can be used to indicate to the web servers 24, 30 the number of fields expected to be present in a signal transmitted from the WAD 12 to the web server 30.

### 7. Resource Access Right Database

The resource access right database defines the rights associated with a particular WAD and/or a user. In the exemplary embodiment of FIG. 9C the resource access right database provides the access rights associated with IP addresses. The following fields can be included in the resource access right database.

Authorized IP Address Range

Data in this field indicates IP addresses of WADs authorized to obtain access to a resource. The address ranges can be defined in terms of four 256-bit numbers as is now standard on the Internet. Of course, additional addressing schemes now existing or that may be developed in the future can be used to define the IP addresses of WADs authorized to access the resource. The field can also be in pneumonic form, i.e., “www.xxxxxxxxx.com/yyyy/yyyy” where the “x”'s indicate a domain name and the “y”'s indicate a field path to the data storage location of the resource, which can be resolved into an IP address by a stored mapping, for example.

IP Address of Resource Provider Server

This field indicates the IP address of the web server 24 of the RPS 14 that initially hosts the resource until distributed to one or more RDS 16. This field can be in mnemonic form.

Retrieval Key Data

This field indicates the key data used to encrypt or decrypt data transmitted between the web servers 24, 30 of the RPS 14 and/or RDS 16. For example, the key data can be used by the web server 30 of the RDS 16 to decrypt the resource transmitted from the RPS 14 to the RDS 16 in response to a request-for-resource signal generated by a WAD.

Lifespan Data for Data Access of URL

This field can contain the start date/time and span of time from such start date/time over which access to the resource is permitted the WAD or user thereof. This field can be used to control access to the resource to only authorized paying subscribers, for example.

Maximum Reference Data

This field represents the maximum number of times a user and/or WAD may access a resource. The web server 30 can track the number of accesses made by the WAD, in which case the maximum reference data can be transmitted in a secure URL from the web server 24 to the web server 30 via the WAD 12. Alternatively, the web server 24 can track the number of accesses to the resource by the WAD by the web server 30 notifying the web server 24 each time the WAD seeks access to the resource. The web servers 24 and/or 30 can store this data along with reference count data that is initially set to “0” and incremented each time the WAD 12 accesses the resource. If the web servers 24 and/or 30 determine that the WAD 12 has exceeded the maximum number of permitted accesses to the resource, such web servers can be programmed to prohibit the WAD 12 from further accessing the resource. The web servers 24 and/or 30 can perform this function by tracking the number of accesses to the resource using a particular secure URL.

Reference Count Data

This field contains data indicating the number of times the resource has been accessed by a WAD and/or user. It is compared against corresponding maximum reference data to determine whether access to the data remains authorized. It should be understood that the reference count data is not stored in the URL, but instead is maintained by the web servers 24 and/or 30.

### 8. Secure URL, the Secure URL Generator Module, and Related Methods

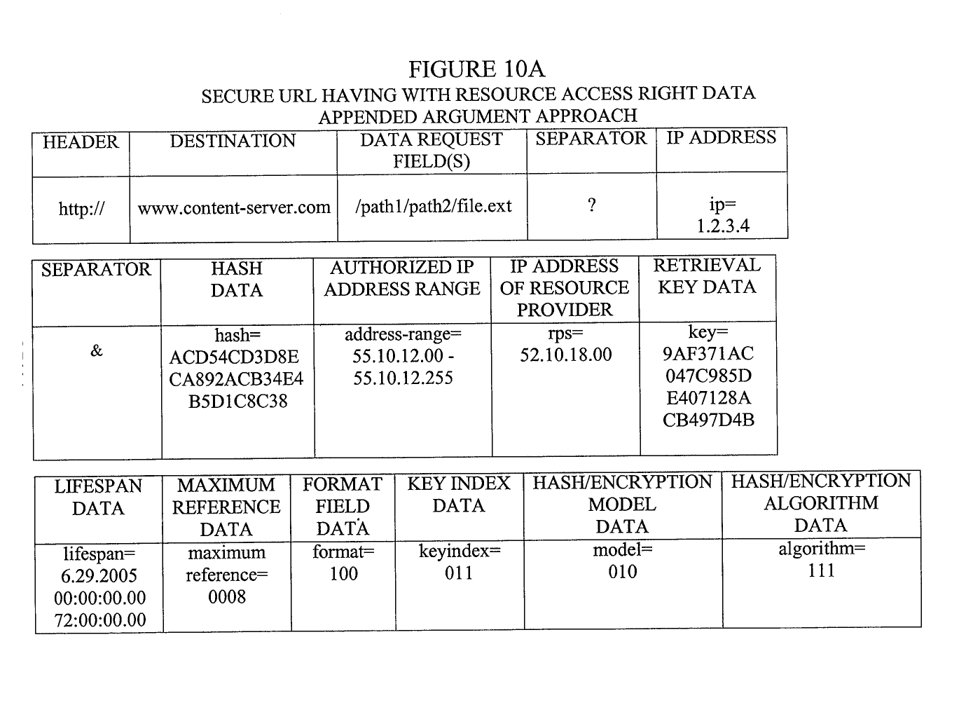

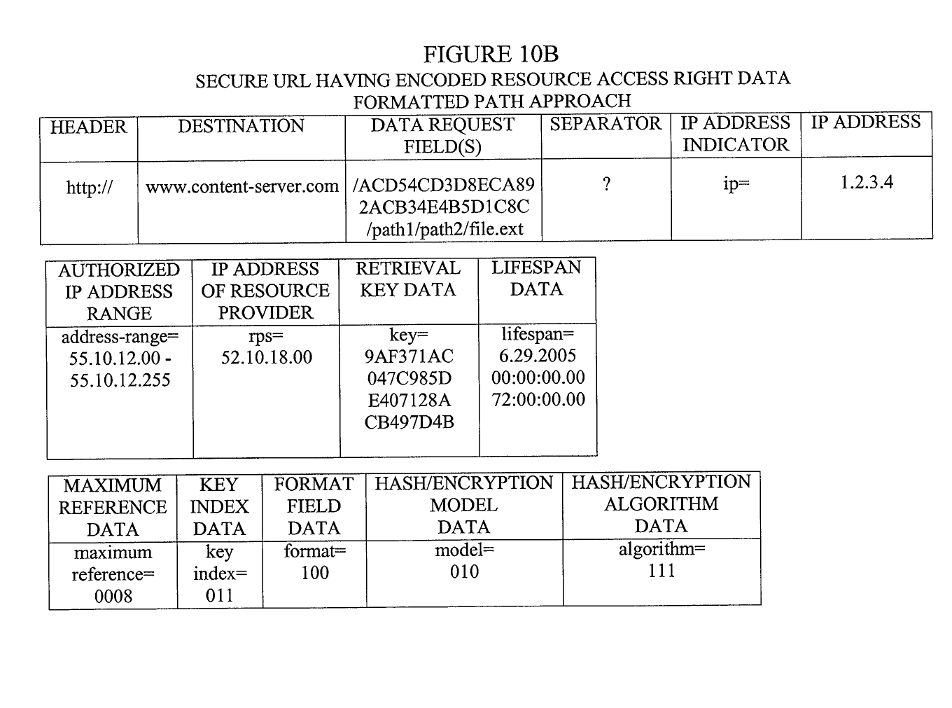

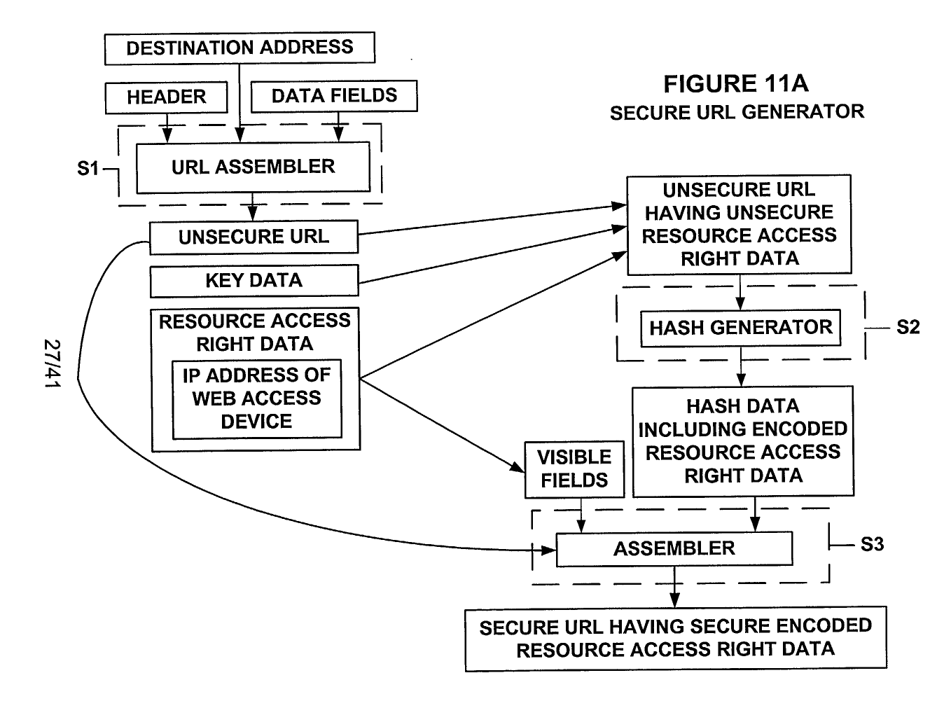

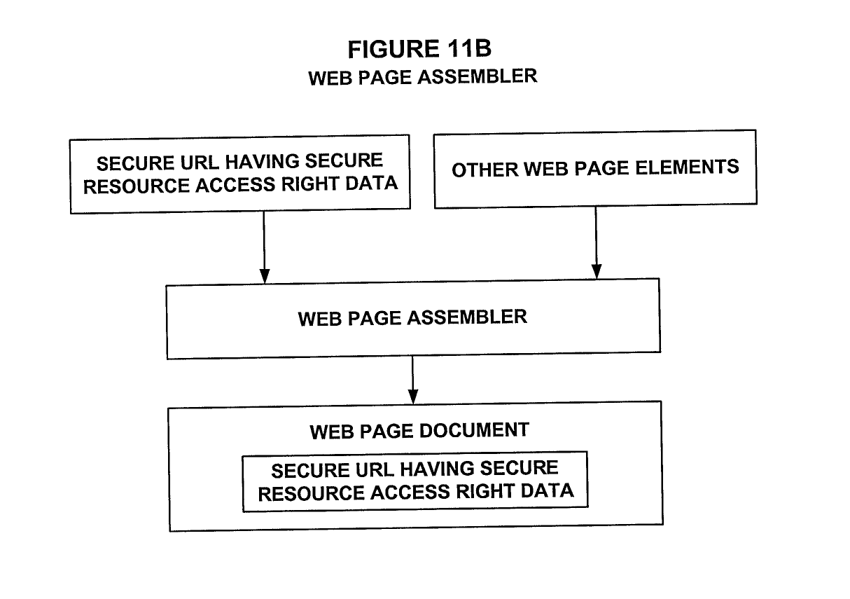

The secure URL generator module functions to generate a URL having resource access right data starting from a URL. The URL with secure resource access right data can be referred to as a “secure URL”. FIGS. 10A and 10B represent a “formatted path” technique for generating a secure URL, and FIGS. 11A and 11B represent a “appended argument” approach to generating a secure URL. In the formatted path approach to encoding resource access right data with the URL, an original URL:

http://www.content-server.com/path1/path2/file.ext

becomes

http://www.content-server.com/secure_resource_access_right_data/path1/path2/file.ext

Thus, the resource access right data becomes a part of the file path leading to the resource requested by the WAD 12. The appended argument approach takes a different form:

http://www.content-server.com/path1/path2/file.ext?secure_resource_access_right_data

Hence the appended argument approach appends the secure resource access right data to the end of the URL. These are but two examples of techniques for generating a secure URL and others may occur to those skilled in this technology.

In FIGS. 10A and 10B the form of the unsecure URL includes a header field “http://”, a destination field “www.content-server.com”, a data request field(s) “path1/path2/file.ext” in which “path1” and “path 2” are paths identifying the location of a resource file, “file” is the resource file itself, and “.ext” is an extension such as “.txt”, “.doc”, “.jpg”, “.tif”, “.bmp”, “.mpg”, “.wav”, “.avi”, etc. that identifies the nature of the file. The separator is a character to distinguish the path and file name from the remainder of the fields. In this case the separator is “?”. The Internet protocol (IP) address indicator “ip=” signifies to the web server 30 the IP address of the WAD 12 generating the request-for-access-to-resource signal. In this example, the IP address of the WAD 12 is “1.2.3.4”. The end IP address and the beginning of the hash indicator field is designated by a separator, in this case “&”. The unsecure URL includes a hash indicator field “hash=” having a value “ACD54CD3D8ECA892ACB34E4B5D1C8C38” in this example. The hash is the result of the hash algorithm applied to at least the IP address but possibly other fields defining the resource access right data or possibly secure content key data included in the secure URL. Such fields have been previously described in connection with the resource access right database and the secure content key database.

FIG. 11A is an exemplary method for generating a secure URL having resource access right data. This method can be performed by the web server 24 of the RDS 14 to generate secure resource access right data combined with a respective URL in a web page document requested by a user of a WAD 12. In step S1 of FIG. 11A the header data (e.g., “http://” or “ftp://”), the destination IP address (i.e., the IP address of the web server 30) and data fields (i.e., the file path to the resource), are combined to generate an unsecure or basic URL. Step S1 can be performed by a URL assembler of the secure URL generator module. In step S2 of FIG. 11A the unsecure URL, the key data, the IP address of the WAD 12, and the resource access right data, are combined to form an unsecure URL with unsecure resource access right data. The key data can be retrieved from the secure resource key database using the corresponding URL in the web page document as a reference to retrieve this data. The resource access right data can be retrieved from its database using the IP address of the WAD 12 and/or the user name and password established through a log-in procedure, for example. As previously described, the resource access right data can include authorized IP address range, IP address of resource provider server, retrieval key data, lifespan data for data access for URL, and maximum reference data, for example. In step S2 the unsecure URL having resource access right data with appended key data is hashed using a hash generator of the secure URL generator module to generate hash data that includes resource access right data. In step S3 the unsecure URL generated in step S1, data for any visible fields that are to be included in the secure URL and intended to be freely accessible in transmission over the network 18, and hash data including the resource access right data, are combined together and encoded into a form that can be handled by a server to generate the secure URL with resource access right data. Step S3 can be performed by a message assembler of the secure URL generator module.

The RPS 14 incorporates the secure URL(s) into a web page document for transmission to the requesting WAD 12 and/or user. As shown in FIG. 11B the secure URL generator module can include a web page assembler receiving the secure URL(s) with secure resource access right data and other web page elements such as HTML code with applets, image, text, sound, and/or video files or clips, etc. The web page assembler module combines the elements of the web page document with the secure URL. The RPS 14 can transmit the resulting web page document with secure URL to the WAD 12.

The hash generator of the secure URL generator module can generate the hash data including the resource access right data using a hash algorithm such as SHA-1 or DES upon selected data contained within the secure URL. The specific hash or encryption scheme used to hash or encrypt resource access right data is not particularly important to the invention, but it is generally desirable that:

(1) both the secure URL generator module and the rights management enforcer module use the same hash or encryption format and encryption/decryption algorithm;

(2) the IP address and an indication of the hash or encryption key if there are alternatives be included in the resource access right data; and

(3) the hash or encryption key not be visible as part of the unencrypted data in the secure URL.

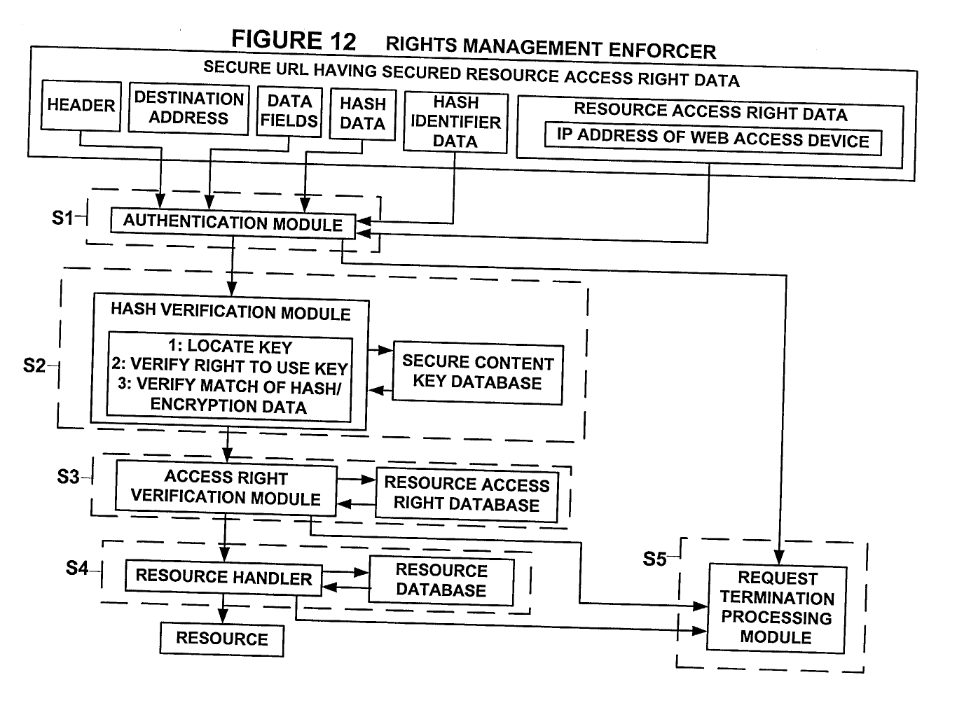

FIG. 12 is a method for decoding resource access right data within a secure URL. The method can be performed by the web server 30 of the RDS 16 upon receiving a request signal from the WAD 12 including the secure URL with resource access right data. In step S1 of FIG. 12 the authentication module receives the data field(s) indicating a path to the data storage location of the resource. The authentication module also receives hash data representing the portion of the resource access right data hashed by the RPS 14. In this example, the hashed data is the result of hashing the IP address. The authentication module further includes hash identifier data such as the hash index that indicates the hash algorithm used by the RPS 14 to produce the hash data. The authentication module also receives the resource access right data including the IP address of the WAD. The resource access right data can be in either encrypted, visible, or hybrid form. The authentication module can perform a check of the format of the secure URL and resource access right data to ensure they have proper form readable by the web server 30 of the RDS 16. If the secure URL does not have the proper format, the authentication module passes the resource request to the request termination processing module. The authentication module authenticates that the WAD and/or user generated the request to access a resource. For example, the authentication module can perform this function by comparing the IP address within the resource access right data to the IP address included in the header of the HTTP formatted message to ensure that they are the same IP address. If the IP address match, the authentication module passes the authenticated data to the hash verification module. If the IP address do not match, the authentication module passes the resource request to the request termination processing module.

If the resource request from the WAD is authenticated, the hash verification module uses the URL of the resource request to look-up the key data appropriate to use with the RPS 14. The corresponding key data can be retrieved and used by the web server 30 to decrypt resource access right or other data within the secure URL. If there is more than one key used with the URL of the RPS 14, key index data will be included in the secure URL by the RPS 14. This key index data can be extracted from the secure URL and used by the hash verification module to retrieve the appropriate key. The hash verification module can also verify the right to use the key using data in the secure content key database. For example, the hash verification module can compare start date/time, end date/time, and/or lifespan data with the date/time of the request to determine whether the key is valid. If not, the hash verification module passes the resource request to the request termination processing module. The hash verification module can also determine whether the WAD and/or user are authorized to access the requested resource by using the hash identifier data to perform a corresponding hash algorithm on all or a portion of the resource access right data. More specifically, the hash verification module appends the key data to the resource access right data and performs the appropriate hash algorithm on this data to produce hash data. If the hash data produced by the authentication module matches the hash data in the secure URL in the resource request message from the WAD 12, the hash verification module passes the verified data to the resource access right verification module. Conversely, if the hash data do not match, the hash verification module passes the resource request to the requesting termination processing module.

If the hash verification module verifies the right to use the key and matches the hash/encryption data, the resource access right verification module determines whether access to the resource is authorized. Resource authorization can be performed by checking the lifespan data from the resource access right database, against the date/time of the resource request. Resource authorization can also be performed by incrementing the reference count data in the resource access right database and comparing the incremented value with the maximum reference data. If the reference count data is less than the maximum reference data, the access right verification module passes the resource request to the resource handler. Conversely, if access to the resource is not authorized, for example, due to expiration of the time permitted to access the resource or due to exceeding the maximum allowed number of accesses to the resource, the access right verification module passes the resource request to the request termination processing module. The request termination processing module is executed by the web server 30 to transmit notification to the WAD and/or user that the resource request has been denied.

Upon receiving a resource request from the access right verification module, the resource handler retrieves the resource from either the data storage unit 26 or 32. If the resource had been previously requested, the data storage unit 32 stores the resource. However, if the resource request has been made for the first time, the web server 30 of the RDS 16 retrieves the resource from the web server 24 of the RPS 14. The web server 30 executes the resource handler module to provide access to the resource for the requesting WAD and/or user.

In FIG. 12, the secure URL having secure resource access right data can be provided to the access right management enforcer module via the communication module as shown in FIG. 5. The authentication module, hash verification module, and access right module of FIG. 12 can be included in the access right enforcer module of FIG. 5. The resource handler of FIG. 12 can be included in the secure caching module of FIG. 5.

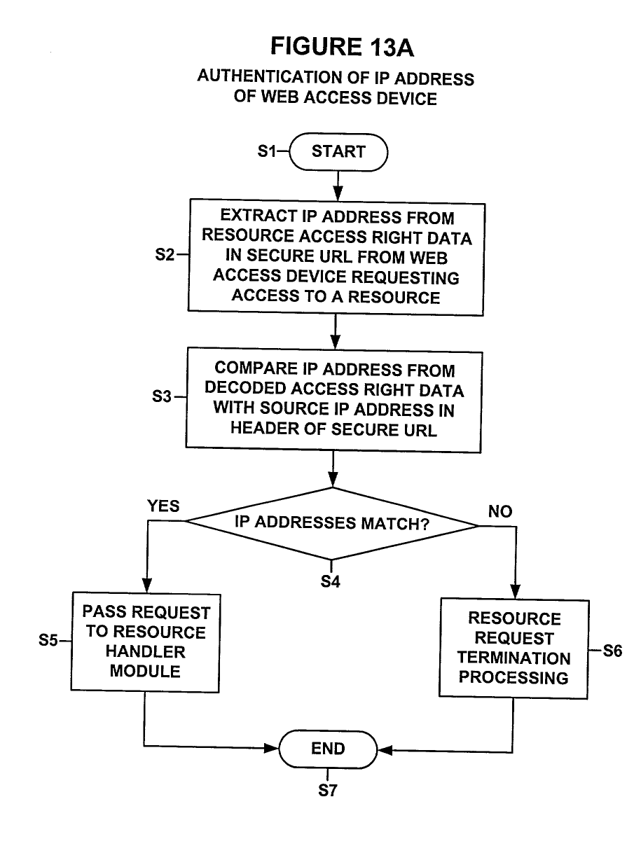

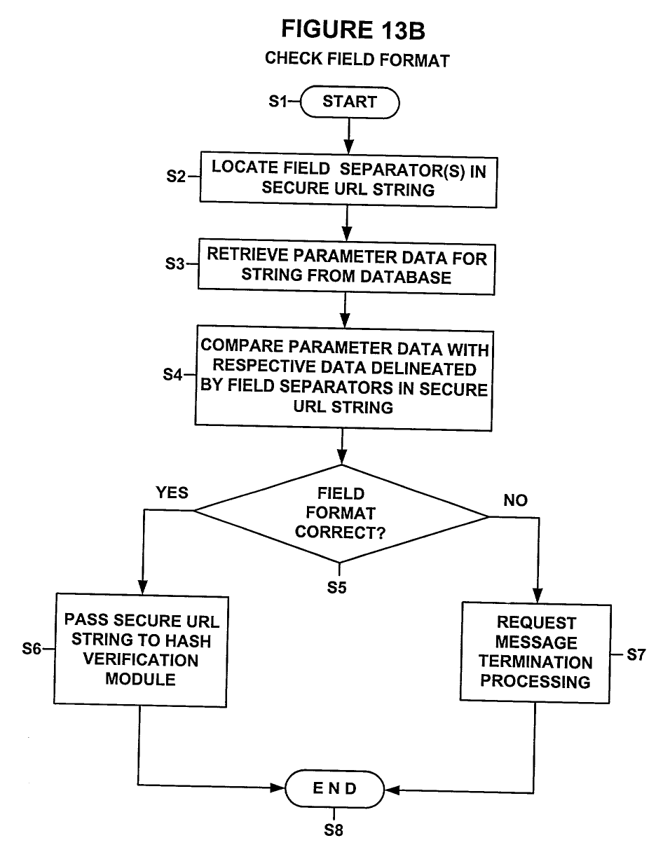

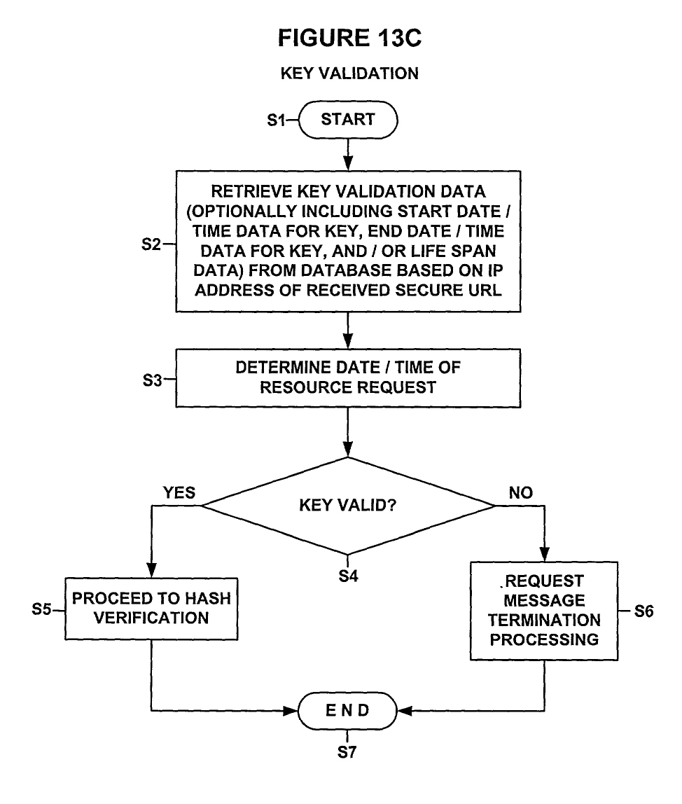

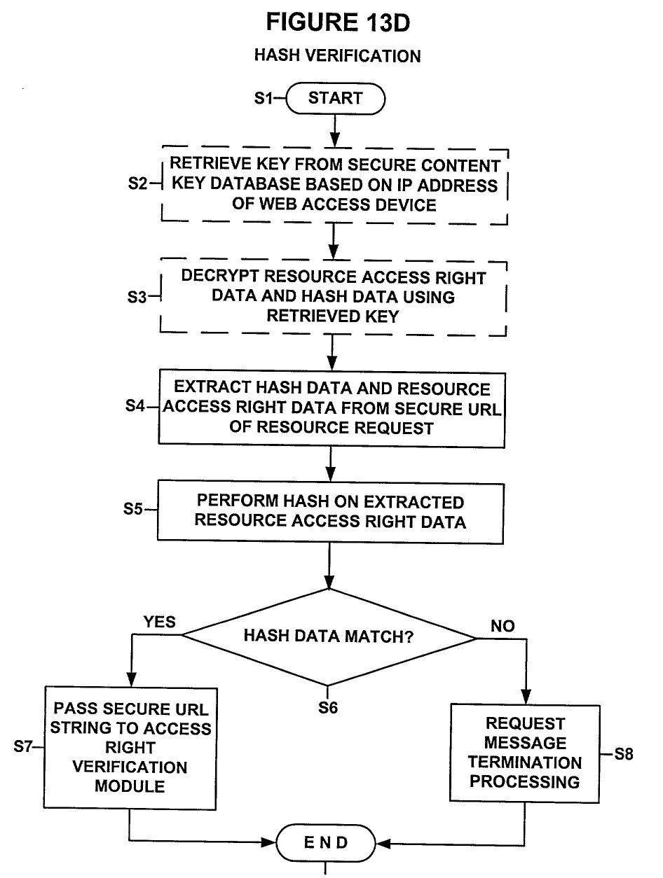

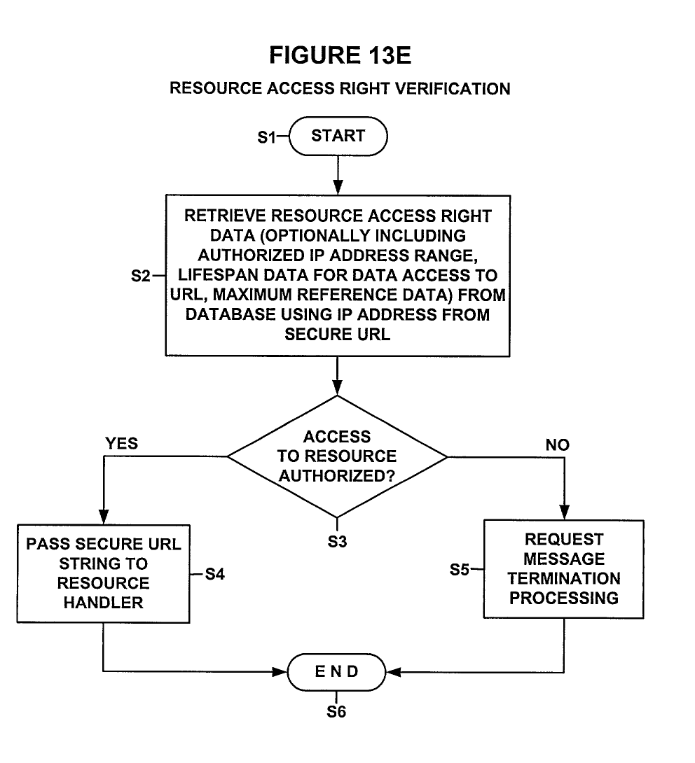

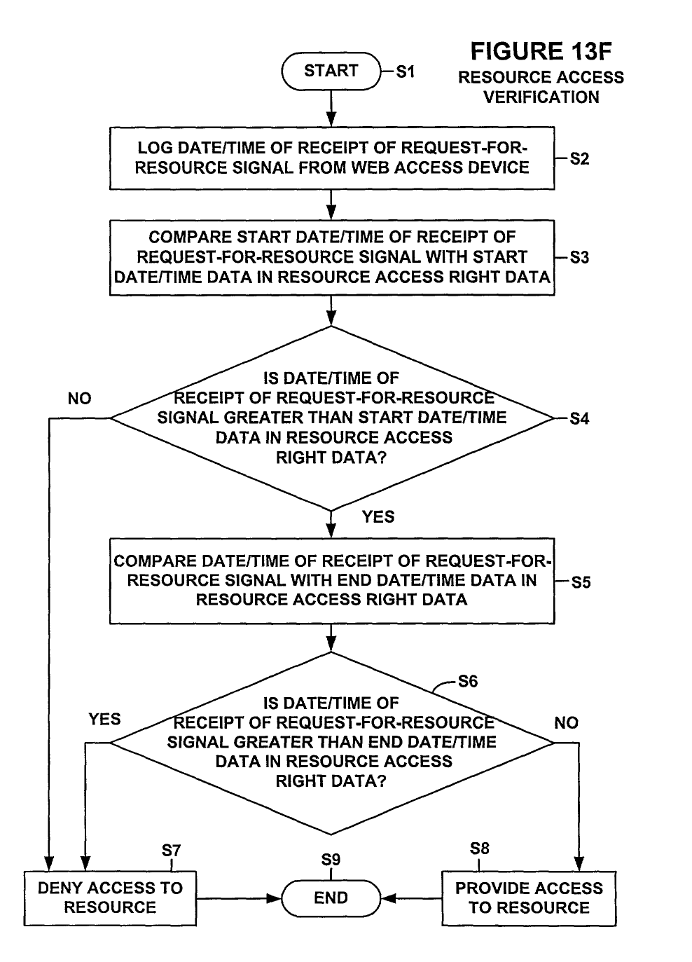

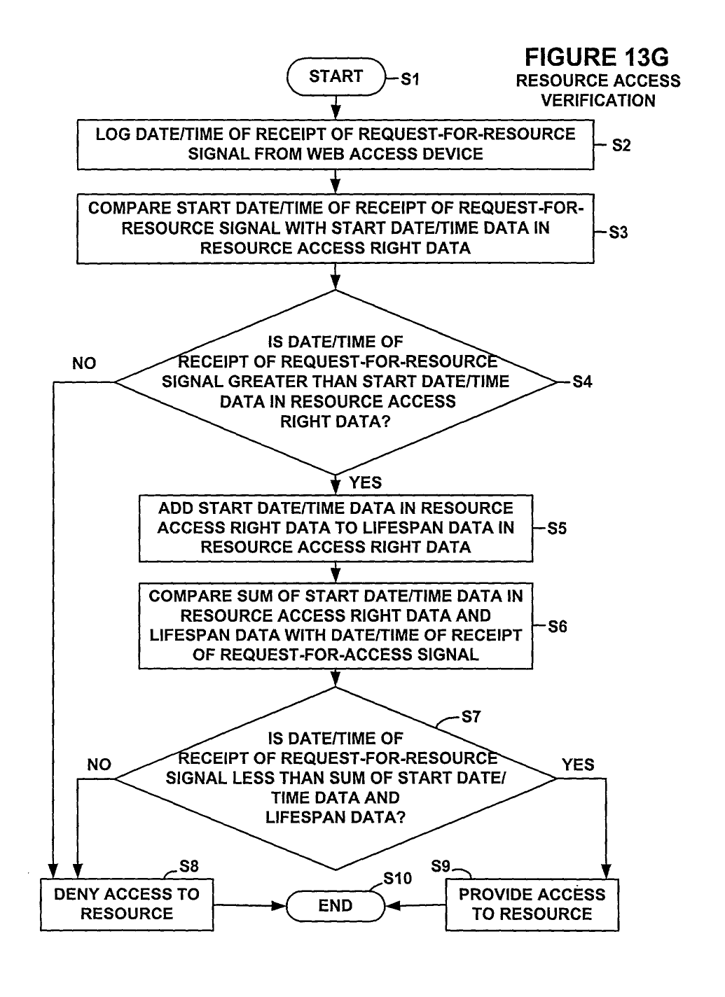

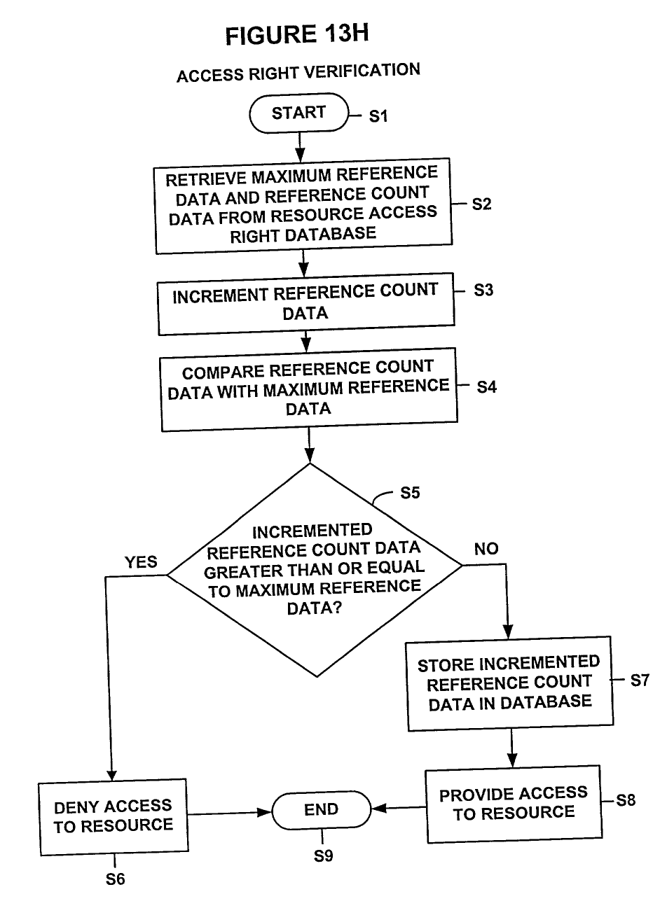

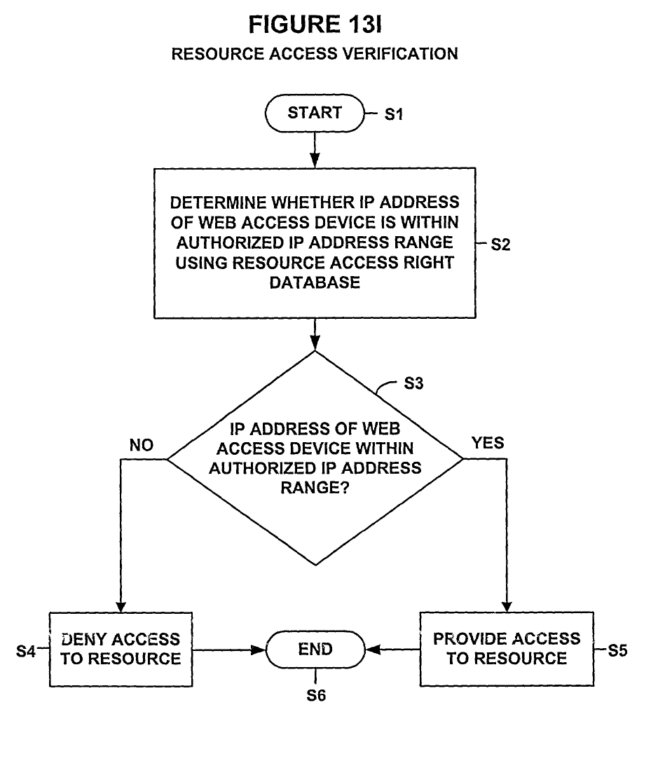

FIG. 13A is a flowchart of a method for authenticating an IP address of a WAD. The method can be performed by the web server 30 in executing the authentication module, for example. In step S1 the method begins. In step S2 the IP address is extracted from resource access right data included in the secure URL of a resource request. In step S3 the web server 30 compares the IP address from the resource access right data with the source IP address in the HTTP message header of the secure URL message. In step S4 a determination is made to establish whether the IP address in the resource access right data and the header match. If so, in step S5, the resource request is passed to the resource handler module. Conversely, if the determination in step S4 is negative, in step S6 the resource request is passed to the resource request termination processing module to terminate the resource request. After performance of step S6 or S9, the method of FIG. 13A ends in step S7.

FIG. 13B is a flowchart of processing performed to check the field format of a secure URL request. The method can be performed by the web server 30 in execution of the authentication module. In step S1 the method of FIG. 13B begins. In step S2 field separators are located in the secure URL string. In step S3 parameter data defining the format of the secure URL string is retrieved by the web server 30 from its memory. This data can indicate field separators, maximum number of characters for each field, and a check for characters that are not allowed within a field data string. In step S4 the data delineated by field separators in the secure URL string is compared with the parameter data. In step S5 a determination is made to establish whether the field format is correct based on the comparison of step S4. If so, in step S6 the secure URL string is passed to the hash verification module. Conversely, if the field format is determined not to be proper in step S5, the resource request is passed to the resource message termination processing module for termination of the resource request. After performance of steps S6 or S7, processing performed by the web server 30 terminates in step S8.

FIG. 13C is a flowchart of processing performed by the hash verification module to determine whether access to the resource is authorized. In step S1 the method of FIG. 13C begins. In step S2 key validation data is retrieved from the secure content key database using the IP address of the WAD. The key validation data can include the start date/time, end date/time, or lifespan data for the key. This can be done by accessing a log to determine when the request was made, or by checking the date/time at performance of step S3. In step S4 a determination is made to establish whether the key is valid based on the determination of step S3. If so, in step S5 the resource request is passed to hash verification processing. Conversely, if the determination in step S4 is not valid, the method proceeds to step S6 for performance of request message termination processing. After performance of step S5 or S6, the method of FIG. 13C terminates in step S7 of FIG. 13C.

FIG. 13D is a flowchart of processing performed to verify hash data included within the secure URL of the resource request message to ensure that the resource has not been corrupted in transmission or tampered with. In step S1 the method of FIG. 13D begins. In step S2 a key is retrieved from the secure content key database based on the IP address of the WAD requesting access to a resource. In step S3 the resource access right data and hash data are decrypted with the key. Steps S2 and S3 are optional steps and may be omitted if encryption of resource access right data is not required during transmission over the network 18. In step S4 hash data and resource access right data are extracted from the secure URL of the resource request. In step S5 a hash is performed on the extracted resource access right data. In step S6 a determination is made to establish whether the produced hash data matches the hash data received in the secure URL. If the hash data matches, processing proceeds to step S7 in which the resource request is passed to the access right verification module. Conversely, if the hash data does not match in step S6, processing proceeds to step S8 in which termination processing is executed to terminate the resource request. After performance of either step S7 or step S8, the method of FIG. 13D terminates in step S9.

FIG. 13E is a flowchart of a method of verifying that the requesting WAD or user is authorized to access a resource. In step S1 the method of FIG. 13E begins. In step S2 resource access right data is retrieved from the resource access right database using the IP address of the WAD. The resource access right data can optionally include an authorized IP address or address range authorized to access a resource, lifespan data defining the period of time over which the resource can be accessed by the requester, and maximum reference data indicating the maximum number of times a WAD or user can access a resource. In step S3 a determination is made to establish whether the WAD is authorized to access the resource. If so, in step S4 the secure URL of the resource request is passed to the resource handler. Conversely, if the determination in step S3 is negative, in step S5 the resource request message is terminated. After performance of either step S4 or step S5, the method of FIG. 13E terminates in step S6.

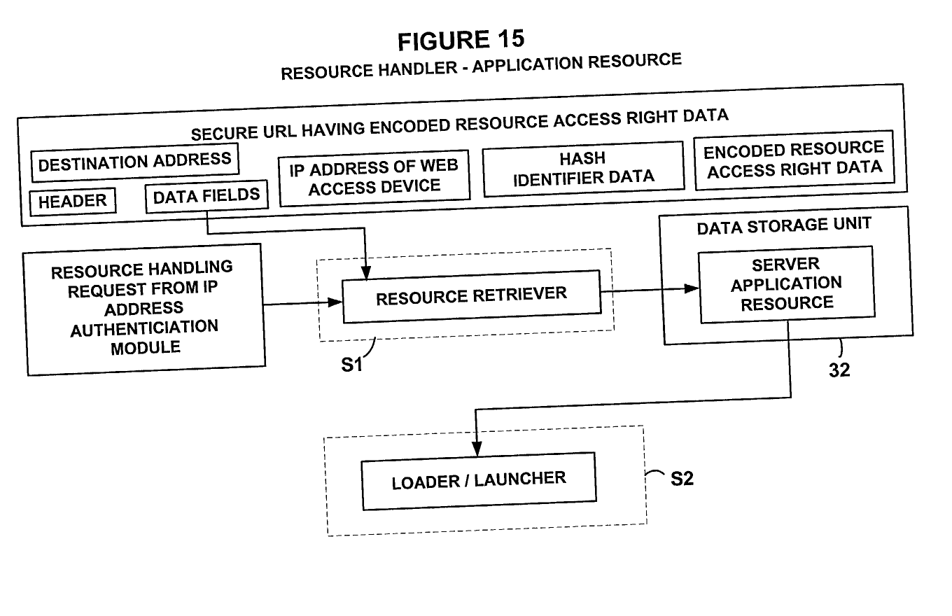

FIG. 13F is a flowchart of processing performed by the processor 54 of the web server 30. The processing is performed to determine whether the request signal from the WAD 12 has been made within the time permitted for accessing the resource as established by the RPS 12. The method of FIG. 13F can be performed by the access right enforcer module executed by the processor 54. In step S1 of FIG. 13F processing performed by the processor 54 begins in step S1. In step S2 the processor 54 logs the date and time of receipt of the request-for-resource signal from the WAD 12. In step S3 the processor 54 compares the start date/time of receipt of the request-for-resource signal with the start date/time data in the decoded resource access right data. In step S4 the processor 54 determines whether the date/time of receipt of the request-for-resource signal is greater than the start date/time data in the resource access right data. If so, in step S5 the processor 54 compares the date and time of receipt of the request-for resource signal with the end date/time data contained in the resource access right data. In step S6 the processor 54 determines whether the date and time of receipt of the request-for-resource signal is greater than the end date/time data in the resource request data. If the determination in steps S4 or S6 are negative, the processor 54 denies access to the resource in step S7. The processor 54 thus prohibits the WAD 12 from accessing the resource. Conversely, if the determination in step S6 is affirmative, in step S8 the processor 54 provides access to the resource. After performance of step S7 or S8 processing performed by the processor 54 terminates in step S9 of FIG. 15.

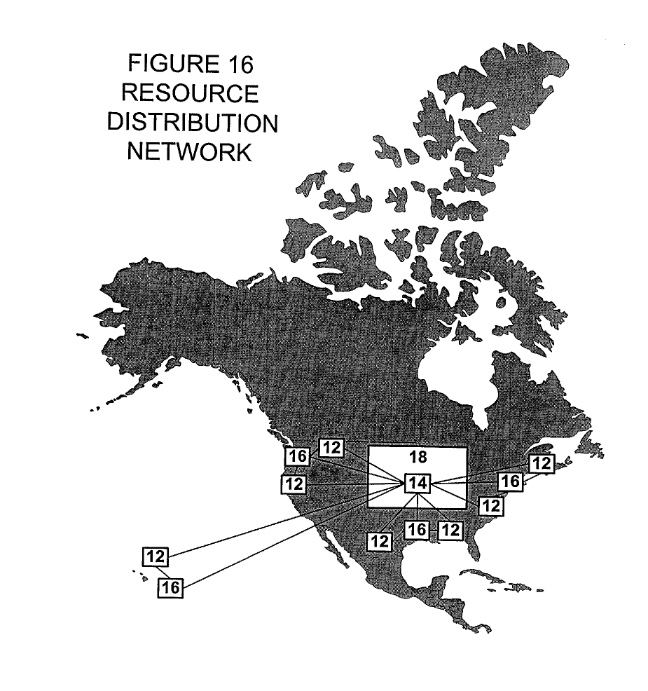

FIG. 13G is a flowchart of processing performed by the processor 54 of the web server 30 to determine whether the WAD 12 and/or user thereof is authorized to access the resource on the start date/time data contained in the decoded resource access right data received in the request-for-resource signal of the WAD 12. The method of FIG. 16 can be performed by the access right enforcer module executed by the processor 54. In step S1 of FIG. 13G processing performed by the processor 54 begins. In step S2 the processor 54 logs the date/time of receipt of the request-for-access signal from the WAD 12. In step S3 the processor 54 compares the start date/time of receipt of the request-for-resource signal with the start date/time data contained within the decoded resource access right data. In step S4 the processor 54 determines whether the date and time of receipt of the request-for-resource signal is greater than the date and time indicated in the decoded resource access right data. If the determination in step S4 is affirmative, in step S5 the processor 54 adds the start date/time in the decoded resource access right data to the lifespan data contained in the decoded resource access right data. In step S6 the processor 54 compares the sum of the date and time in the decoded resource access right data and lifespan data, with the data and time of receipt of the request-for-access signal. In step S7 the processor 54 determines whether the date and time of the receipt of request-for-resource signal is greater than the sum of the start date and time data and the lifespan data. If the determinations in steps S4 or S7 are affirmative, in step S8 the processor 54 denies access to the resource to the WAD 12. Conversely, if the determination in step S7 is affirmative, in step S9 the processor 54 provides access to the resource. After performance of either step S8 or S9 processing performed by the processor 54 terminates in step S10.

FIG. 13H is a flowchart of a method for verifying whether WAD and/or user are permitted to access a resource. The method of FIG. 13H can be performed by the web server 30 of the RDS 16, for example. In step S1 the method of FIG. 13H begins. In step S2 maximum reference data and reference count data are retrieved from the resource access right database. In step S3 the reference count data is incremented. In step S4 the incremented reference count data is compared with the maximum reference data. In step S5 a determination is made to establish whether the incremented reference count data is greater than or equal to the maximum reference count data. If the determination in step S5 is affirmative, in step S6, access to the resource is denied the requesting WAD through request termination processing. Conversely, if the determination in step S5 is negative, processing proceeds to step S7 in which the incremented reference count data is stored in the resource access right database. In step S8 access is provided to the resource. After performance of either step S6 or S8, the method of FIG. 13H terminates in step S9.

FIG. 13I is a flowchart of a method for determining whether a WAD is authorized to access a resource. The method of FIG. 13I can be performed by the web server 30. In step S1 the method of FIG. 13I begins. In step S2 a determination is made to establish whether the IP address of the web access device is within the authorized IP address range using the resource access right database. In step S3 a determination is made to establish whether the IP address of the web access device is within authorized IP address range. If the determination in step S3 is negative, in step S4 access to the resource is denied through resource request termination processing. Conversely, if the determination in step S3 is affirmative, in step S5 access to the resource is provided. After performance of step S4 or S5 the method of FIG. 13I ends in step S6.

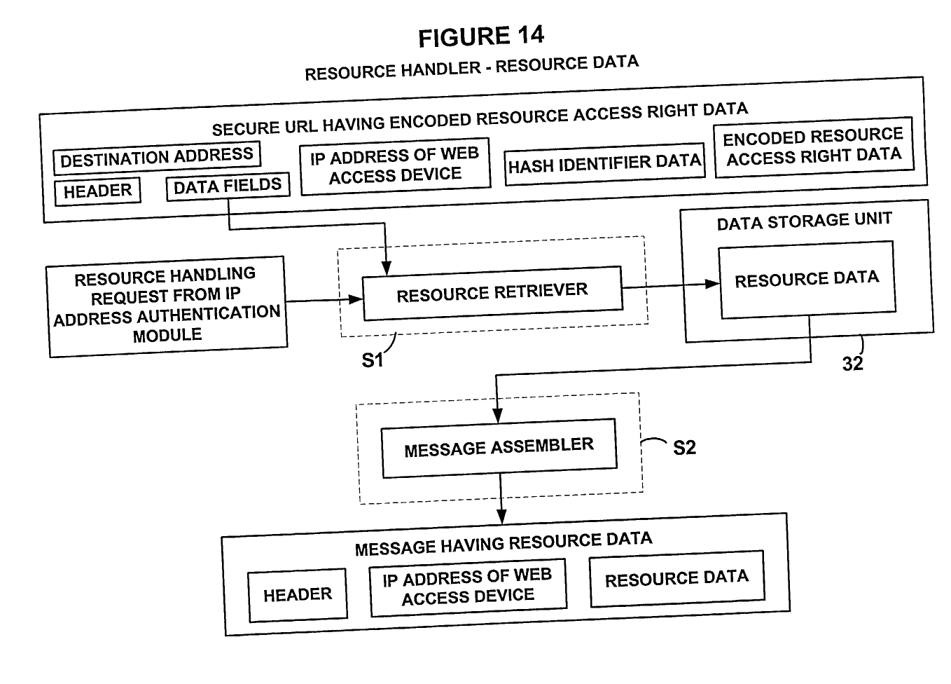

Assuming that access to the resource is permitted by the access right enforcer module of the web server 30, the secure caching module of the web server 30 is used to retrieve resource data and generate a message including the requested resource. In FIG. 14 the resource can be in the form of data such as text, image(s), and/or applet(s) or complete web page document executable by the WAD 12 using its browser application. Alternatively, the resource data can be a program or “plug-in” module downloaded from the web server 30 to the WAD 12 for execution thereon. In step S1 of FIG. 14 a resource retriever of the secure caching module the data fields within the secure URL received from the WAD 12 to retrieve the resource data from the data storage unit 32. The data storage unit 32 supplies the resource data to the message assembler of the secure caching module. In step S2 of FIG. 14 the header from the secure URL message received from the WAD 12 is combined with the IP address of the WAD and the resource data contained in the data storage unit 32 to produce the message having resource data. The processor 54 can call the communication module stored in its memory to transmit the message in the form of a signal to the WAD 12 via the network 18.

FIG. 15 pertains to the processing performed by processor 54 in the case in which the resource data is a server application. The resource retriever receives the data indicating the result of the comparison from step S2 in FIG. 15 and the data fields from the secure URL received from the WAD 12. The resource retriever uses this data and the data fields to retrieve a server application resource from the data storage unit 32. In step S2 the loader/launcher of the secure caching module is executed by the processor 54 to load the server application into the memory 56, and to launch the processor 54 to execute the server application. After launch the server application can interact with the browser or client application of the WAD 12 optionally based on input from the user.

FIG. 16 is an exemplary view demonstrating conceptually how a resource distribution network can be built with the disclosed system. The RPS 14 effectively controls distribution through the use of RDS 16 positioned in different locations within the geographic area served by the system. Requests for web page documents can be served by the RPS 14. Some or all requests for resources referenced by secure URLs within the web page documents distributed to the WADs 12 are serviced by RDS 16. By assigning RDSs 16 to serve WADs 12 that are relatively close in terms of transmission path, the WADs 12 can obtain relatively fast access to requested resources if authorized to receive them.

The many features and advantages of the present invention are apparent from the detailed specification and thus, it is intended by the appended claims to cover all such features and advantages of the described system, subsystem, devices, and methods which follow in the true spirit and scope of the invention. Further, since numerous modifications and changes will readily occur to those of ordinary skill in the art, it is not desired to limit the invention to the exact construction and operation illustrated and described. Accordingly, all suitable modifications and equivalents may be resorted to as falling within the scope of the invention.

1. A method comprising the steps of:
(a) generating hash data based on at least one of a universal resource locator (URL) of a resource, resource access right data defining restriction(s) on a web access device (WAD) and/or user thereof to access the resource, and an internet protocol (IP) address of the WAD; and
(b) combining the hash data, URL, and resource access right data in a web page.

2. A method as claimed in claim 1 further comprising the step of:
(c) transmitting the web page document including the secure URL to the WAD in response to a request for the web page document from the WAD.

3. A method as claimed in claim 1 wherein the hash data is further generated based on key data.

4. A method as claimed in claim 3 wherein steps (a)-(c) are performed at a resource provider subsystem (RDS), the method further comprising the step of:
(c) transmitting the key data from the RPS to a resource distribution subsystem (RDS) hosting the resource so that, if the secure URL is activated by the web access device to generate a request for the resource to the RDS, the RDS can verify that the resource access right data has not been modified other than by the RPS.

5. A method as claimed in claim 1 wherein the resource access right data includes at least one of:
1) an authorized Internet protocol (IP) address or IP address range;
2) lifespan data indicating the lifespan indicating a time period over which requests for accessing a resource are valid; and/or
3) maximum reference data indicating a maximum number of times a web access device and/or user thereof can access a resource.

6. A method comprising the steps of:
at a resource provider subsystem (RPS),
(a) receiving a request for a web page from a web access device via a network, the request including a network address of the web access device;
(b) determining resource access right data for the web access device and/or a user thereof, the resource access right data defining restriction(s) for the web access device and/or user thereof to access a resource;
(c) securing a universal resource locator (URL) for a resource by generating hash data based on at least one of the URL, a network address of the web access device, and/or resource access right data, and combining the URL, resource access right data, and hash data together in the web page; and
(d) transmitting the web page having the secure URL to the web access device via the network in response to the request received in step (a) from the web access device.

7. A method as claimed in claim 6 wherein the hash data is generated further using key data corresponding to the web access device and/or user thereof, the method further comprising the step of:
(e) transmitting key data corresponding to the web access device and/or user thereof to a resource distribution subsystem (RDS) hosting the resource so that, if the secure URL is activated by the web access device to generate a request for the resource to the RDS, the RDS can verify that the resource access right data has not been modified other than by the RPS.

8. A method as claimed in claim 6 wherein the network address of the web access device is an internet protocol (IP) address.

9. A method comprising the steps of:
(a) receiving a signal requesting a web page document from a web access device (WAD), the signal including an Internet protocol (IP) address of the WAD;
(b) retrieving data for the web page document including a universal resource locator (URL) of a document referenced in the web page document;
(c) retrieving resource access right data for the URL using the IP address of the web access device and/or user name and password established through a log-in procedure;
(d) generating hash and/or encrypted data to generate secure resource access right data;
(e) combining the resource access right data with the respective URL to generate a secure URL; and
(f) generating the web page document including the secure URL; and
(g) transmitting the secure URL to the WAD.

10. A method comprising the step of:
at a web access device (WAD),
(a) transmitting a signal requesting a web page document to a resource provider subsystem (RPS); and
(b) receiving the web page document having a secure universal resource locator (URL) with hash data, URL, and resource access right data, in response to the request.

11. A method as claimed in claim 10 further comprising the step of:
(c) activating the secure URL with the WAD to transmit a signal requesting access to a resource designated by the URL to a resource distribution subsystem (RDS); and
(d) accessing the resource with the WAD if the RDS determines that access to the resource is authorized based on the hash data and resource access right data contained in the request signal.

12. A method comprising the steps of:
(a) at a web access device (WAD), generating and transmitting a request for a web page document to a resource provider subsystem (RPS);
(b) receiving the requested web page document having a secure universal resource locator (URL) with secured resource access right data from the resource provider subsystem (RPS);
(c) executing a browser application and web page document with the WAD to generate and transmit a signal to request a resource distribution subsystem (RDS) to provide access to a resource identified by the secure URL, the request signal including the URL and secure resource access right data; and
(d) if access to the resource is permitted by the RDS, accessing the resource with the WAD.

13. A method as claimed in claim 12 wherein the step (d) comprises the substeps of:
(d1) receiving at the WAD resource data from the RDS;
(d2) storing the resource data in memory of the WAD;
(d3) executing an application with the WAD based on the resource data to generate a signal; and
(d4) generating a display with the WAD based on the signal generated in the substep (d3).

14. A method as claimed in claim 12 wherein the step (d) comprises the substeps of:
(d1) receiving a program module resource from the RDS;
(d2) loading the program module resource into memory of the WAD;
(d3) executing the program module resource with the EAD to generate a signal;
(d4) storing the signal(s) in memory; and
(d5) generating a display with the WAD based on the signal generated in the substep (d4).

15. A method as claimed in claim 12 wherein the step (d) comprises the substeps of:
(d1) receiving at the WAD via the network a signal from the RDS generated based on execution of a server application by the RDS;
(d2) storing the received signal in the memory of the WAD;
(d3) generating with the WAD a display signal based on the signal received in the substep (d1);
(d4) generating a display with the WAD based on the display signal;
(d5) executing a client application with the WAD to generate a signal based on the signal from the RDS; and
(d6) transmitting the signal(s) to the RDS via the network.

16. A method as claimed in claim 12 further comprising the step of:
(d7) receiving input data at the WAD from a user, the client application executed in step (d5) based on the input data.

17. A method comprising the steps of:
at a resource distribution subsystem (RDS),
(a) receiving a signal requesting access to a resource from a web access device (WAD), the signal including at least a universal resource locator (URL), resource access right data, and hash data;
(b) verifying that the resource access right data as set by a resource provider subsystem (RPS) has not been changed, using the hash data;
(c) if the verifying establishes that the resource access right data has not been changed, determining whether access to the resource is permitted to the WAD and/or user thereof based on the resource access right data; and
(d) if the resource access right data indicates that the WAD and/or user thereof is authorized to access the resource, permitting access to the resource to the WAD and/or user thereof.

18. A method as claimed in claim 17 wherein the resource access right data includes at least one of:
1) an authorized Internet protocol (IP) address or IP address range;
2) lifespan data indicating the lifespan indicating a time period over which requests for accessing a resource are valid; and
3) maximum reference data indicating a maximum number of times a web access device and/or user thereof can access a resource.

19. A method as claimed in claim 17 wherein the hash data is generated based on the URL, resource access right data, and key data, the method further comprising the step of:
(e) receiving key data from the RPS for use in verifying in step (b) that the resource access right data has not changed from establishment by the RPS.

20. A method as claimed in claim 17 wherein the key data includes a key and optionally at least one of:
1) a second URL identifying the RPS;
2) start date/time data identifying a date and time at which a key is valid;
3) end date/time data identifying a date and time at which a key becomes invalid;
4) lifespan data indicating a period of time over which the key is valid;
5) key index data identifying the key from among a plurality of different keys;
6) hash identifier data indicating to the RDS a hash algorithm to be performed to generate the hash data;
7) encryption data indicating an encryption model and/or algorithm used to encrypt and decrypt resource access right data; and
8) format fields data indicating the number of fields in the signal requesting access to the resource.

21. A method comprising the steps of:
(a) receiving a signal requesting access to a resource, the signal having a secure universal resource locator (URL) with secured resource access right data;
(b) extracting an Internet protocol (IP) address from the secured resource access right data;
(c) comparing the extracted IP address with the IP address included in a hypertext transport protocol (HTTP) message of the request signal; and
(d) authenticating that the IP address of the secured resource access right data corresponds to the IP address of a device requesting access to the resource, based on the comparing of step (c).

22. A method as claimed in claim 21 further comprising the step of:
(e) terminating the request signal if the authenticating of step (d) indicates that the IP address of the secured resource access right data does not match the IP address extracted from the HTTP message.

23. A method as claimed in claim 22 further comprising the steps of:
(e) if the authenticating of step (d) indicates that the IP address of the secure resource access right data matches the IP address of the device requesting access to the resource, obtaining a key corresponding to the IP address;
(f) verifying whether the key is valid based on data corresponding to the key in a secure content key database;
(g) generating hash data based on at least the IP address, URL, and key; and
(h) verifying that the hash data generated in the step (g) matches the hash data included in the request signal received in the step (a).

24. A method as claimed in claim 23 further comprising the steps of:
(i) terminating the request signal if the verifying of the step (h) indicates that the hash data generated in the step (g) does not match the hash data included in the request signal received in the step (a).

25. A method as claimed in claim 23 further comprising the steps of:
(i) determining whether access to a resource is to be provided to a device identified by the IP address, based on the resource access right data included in the request signal;
(j) retrieving the resource based on the URL included within the request signal; and
(k) providing access to the resource to a device identified by the IP address if the determining of step (j) indicates that access to the resource is to be provided, based on the URL.

26. A method as claimed in claim 25 further comprising the steps of:
(l) retrieving resource access right data from a database, the determining of step (j) based further on whether the IP address of the request signal is authorized to access the resource indicated by the URL of the request signal, based on the retrieved resource access right data.

27. A method as claimed in claim 26 further comprising the steps of:
(m) terminating the request signal if the determining of the step (l) indicates that access to the resource is not to be provided based on the resource access right data included in the request signal.

28. A method as claimed in claim 26 wherein the resource access right data retrieved in the step (k) includes maximum reference data and reference count data, the method further comprising the step of:
(n) incrementing the reference count data to indicate that access to the resource has been requested by the request signal;
(o) comparing the incremented reference count data with the maximum reference count data; and
(p) providing access to the resource if the comparing of step (o) indicates that the incremented reference count data does not exceed the maximum reference count data.

29. A method as claimed in claim 26 wherein the resource access right data retrieved in the step (k) includes lifespan data for access to the resource indicated by the URL, the method further comprising the steps of:
(m) determining a time and date of receiving the request signal in step (a);
(n) comparing the lifespan data with the time and date of receiving the requesting signal; and
(o) determining that the IP address of the request signal is authorized to access the resource, if the comparing of the step (n) indicates that the time and date of receiving the request signal is within the lifespan data.

30. A method as claimed in claim 29 wherein the resource access right data retrieved in the step (k) includes URL/resource provider identification data, the method further comprising the step of:
(p) retrieving the resource from a resource provider subsystem via the Internet, based on the URL/resource provider identification data, the retrieved resource used to provide access to the resource in the step (k).

31. A method as claimed in claim 30 wherein the resource access right data retrieved in the step (l) includes retrieval key data used to decrypt the resource retrieved in the step (p).

32. A method comprising the steps of:
(a) receiving a signal requesting access to a resource, the request signal including a universal resource locator (URL), secured resource access right data, and an Internet protocol (IP) address of a device requesting access to the resource, and hash data;
(b) verifying whether key data is valid based on data corresponding to the key data in a secure content key database;
(c) if the key data is verified as valid in step (b), generating hash data based on at least the IP address, URL, and the key data; and
(d) verifying that the hash data generated in the step (c) matches the hash data included in the request signal received in the step (a).

33. A method as claimed in claim 32 further comprising the steps of:
(e) terminating the request signal if the verifying of the step (d) indicates that the hash data generated in the step (c) does not match the hash data included in the request signal received in the step (a).

34. A method as claimed in claim 33 further comprising the steps of:
(f) determining whether access to a resource is to be provided to a device identified by the IP address, based on the resource access right data included in the request signal; and
(g) providing access to the resource to a device identified by the IP address if the determining of the step (f) indicates that access to the resource is to be provided.

35. A method as claimed in claim 34 further comprising the steps of:
(h) retrieving resource access right data from a database, the determining of step (f) based further on whether the IP address of the request signal is authorized to access the resource indicated by the URL of the request signal, based on the retrieved resource access right data.

36. A method as claimed in claim 32 wherein the request signal received in step (a) includes key index data, the method further comprising the step of:
(e) retrieving the key data from the secure content key database using the key index data.

37. A method as claimed in claim 32 wherein the step (b) comprises the substeps of:
(b1) determining a date and time of receiving the request signal in the step (a);
(b2) retrieving start date/time data and end date/time date from a database;
(b3) comparing the date and time of the request signal with the start date/time data and end date/time data; and
(b4) determining whether the key data is valid, based on the comparing of the step (b3).

38. A method as claimed in claim 32 wherein the step (b) comprises the substeps of:
(b1) determining a date and time of receiving the request signal in the step (a);
(b2) retrieving lifespan data from a database;
(b3) comparing the date and time of receiving the request signal with the lifespan data; and
(b4) determining whether the key data is valid, based on the comparing of the step (b3).

39. A method comprising the steps of:
(a) receiving via the Internet a request signal including a universal resource locator (URL) indicating a location of a resource, secured resource access right data indicating rights of a device to access the resource, and an Internet protocol (IP) address of the device;
(b) determining whether access to the resource is to be provided to the device identified by the IP address, based on secured resource access right data included in the request signal; and
(c) providing access to the resource to a device identified by the IP address if the determining of the step (c) indicates that access to the resource is to be provided.

40. A method as claimed in claim 39 further comprising the step of:
(d) terminating the request signal if the determining of the step (b) indicates that access to the device is not authorized.

41. A method as claimed in claim 39 wherein said step (c) comprises the substep of transmitting the resource to the device via the Internet.

42. A method as claimed in claim 39 further comprising the step of:
(d) authenticating the request signal if an Internet protocol (IP) address of the URL in the request signal matches a URL of the device contained in the resource access right data of the request signal.

43. A method as claimed in claim 39 further comprising the steps of:
(d) retrieving resource access right data from a database,
the determining of step (b) based further on whether the IP address of the request signal is authorized to access the resource indicated by the URL of the request signal, based on the retrieved resource access right data.

44. A method as claimed in claim 39 further comprising the step of:
(d) verifying validity of key data;
(e) generating hash data based on at least the URL and the key data;
(f) comparing the hash data generated in step (e) with hash data included in the received request signal;
(g) determining whether the hash data generated in step (e) matches the hash data generated in the request signal, based on the comparing of the step (f),
the access to the resource provided in step (c) if the determining of step (g) establishes that the hash data match.

45. A method as claimed in claim 44 wherein the step (d) comprises the substeps of:
(d1) determining a date and time of receiving the request signal in the step (a);
(d2) retrieving start date/time data and end date/time date from a database;
(d3) comparing the date and time of the request signal with the start date/time data and end date/time data; and
(d4) determining whether key data is valid, based on the comparing of the step (b3),
steps (e) through (g) performed if the key data is determined to be valid and not otherwise.

46. A method as claimed in claim 44 wherein the step (d) comprises the substeps of:
(d1) determining a date and time of receiving the request signal in the step (a);
(d2) retrieving lifespan data from a database;
(d3) comparing the date and time of receiving the request signal with the lifespan data; and
(d4) determining whether key data is valid, based on the comparing of the step (b3),
steps (e) through (g) performed if the key data is determined to be valid and not otherwise.

47. A system using the Internet, the system comprising:
at least one web access device (WAD) executing a browser application, the WAD generating a signal requesting a web page document having a secure universal resource locator (URL), receiving the web page document having the secure URL, displaying the web page document having the secure URL, and generating a signal requesting a resource indicated by the secure URL of the web page document;
a resource provider subsystem (RPS) coupled to receive via the Internet the signal requesting the web page document from the WAD, the RPS generating the secure URL to include resource access right data defining restriction(s) of the WAD and/or user thereof to access the resource indicated by the URL, the RPS transmitting the web page document with the secure URL to the WAD; and
at least one resource distribution subsystem (RDS) coupled to receive via the Internet the signal from the WAD requesting access to the resource, the RDS determining whether the resource access right data has been changed from establishment by the RPS, and, if the RDS determines that the resource access right data has not been changed, the RDS determining whether the WAD and/or user thereof is authorized to access the resource using the resource access right data, the RDS permitting access to the resource if the WAD and/or user thereof is authorized to access the resource.

48. A system as claimed in claim 47 wherein the resource access right data includes at least one of:
1) an authorized Internet protocol (IP) address or IP address range;
2) lifespan data indicating the lifespan indicating a time period over which requests for accessing a resource are valid; and/or
3) maximum reference data indicating a maximum number of times a web access device and/or user thereof can access a resource.

49. A system as claimed in claim 47 wherein the hash data is generated by the RPS based on the URL, resource access right data, and key data, and the RDS stores the key data used by the RPS, the RDS verifying that the resource access right data has not changed from establishment by the RPS using the key data.

50. A system as claimed in claim 47 wherein the key data includes a key and optionally at least one of:
1) a second URL identifying the RPS;
2) start date/time data identifying a date and time at which a key is valid;
3) end date/time data identifying a date and time at which a key becomes invalid;
4) lifespan data indicating a period of time over which the key is valid;
5) key index data identifying the key from among a plurality of different keys;
6) hash identifier data indicating to the RDS a hash algorithm to be performed to generate the hash data;
7) encryption data indicating an encryption model and/or algorithm used to encrypt and decrypt resource access right data; and/or
8) format fields data indicating the number of fields in the signal requesting access to the resource.

51. A server storing a secure universal resource locator (URL) generator module executable by the server to generate a URL having secure resource access right data defining restriction(s) on a web access device (WAD) and/or user thereof to access a resource indicated by the secure URL, the resource access right data secured by the server so that modification of the resource access right data can be detected.

52. A server as claimed in claim 51 wherein the server stores a secure content key database having key data, and the server executes the secure URL generator module to secure the resource access right data with the key data.

53. A server as claimed in claim 51 wherein the server appends the key data to an Internet protocol (IP) address of the WAD requesting the web page document from the server, and hashes the key data and the IP address to generate hash data, the hash data combined with the URL and resource access right data to generate the secure URL.

54. A server as claimed in claim 51 wherein the server uses the key data to encrypt the resource access right data and combines the encrypted resource access right data with the URL to produce the secure URL.

55. A server as claimed in claim 51 wherein the server comprises a resource access right database storing the resource access right data.

56. A server as claimed in claim 51 wherein the server comprises an access right enforcer module, the server executing the access right enforcer module to determine whether a resource is to be provided to another server in response to a request signal received from the other server via the Internet, the server executing a secure caching module to transmit the resource to the other server for distribution if the resource access right data indicates that the other server is authorized to access the resource, and the server preventing access to the other server if the resource access right data indicates the other server is not authorized to access the resource.

57. A server of a resource distribution subsystem (RDS) storing an access right enforcer module executable by the server, the server executing the access right enforcer module in response to a signal from a web access device (WAD) requesting access to a resource, the request signal having a universal resource locator (URL) with secure resource access right data, the server executing the access right enforcer module using resource access right data to determine whether the resource access right data has been modified after its establishment by a resource provider subsystem (RPS), the server preventing access to the resource if the resource access right data has been modified after its establishment, the server further executing a secure caching module if the resource access right data has not been modified to provide access to the resource if the WAD is determined by the server to have the right to access the resource based on the resource access right data, and the server blocking access to the resource if the WAD is determined not to have the right to access the resource.

58. A server as claimed in claim 57 wherein the request signal received by the server from the WAD includes an Internet protocol (IP) address, a universal resource locator (URL) indicating the location of the resource, and hash data, the server retrieving key data based on the IP address and/or URL, the server combining the key data with at least the IP address and/or URL, the server generating hash data based on the key data and IP address and/or URL, the server comparing the server-generated hash data with the hash data in the request signal, the server executing its secure caching module to provide access to the resource if the hash data matches, and the server blocking access to the resource if the hash data do not match.

59. A server as claimed in claim 57 wherein the server retrieves date/time data from a secure content key database stored therein, the date/time data indicating a period of time over which the key data is valid, the server recording the date and time of receiving the request signal at the server and comparing the date and time of receipt of the request signal with the date/time data to determine whether the key data is valid, the server permitting further processing of the request signal if the comparison indicates the key data is valid, and the server terminating further processing of the request signal if the date/time data indicates the key data is not valid.

60. A server as claimed in claim 59 wherein the server further retrieves from the secure content key database life span data that the server uses in conjunction with the date/time data to determine the period of time over which the key is valid so that date and time of receiving the request signal at the server can be compared by the server with the date/time data and lifespan data to determine whether the key is valid.
